(19) United States
(12) Patent Application Publication
(10) Pub. No.: US 2023/0232856 A1
(43) Pub. Date: Jul. 27, 2023

(54) REDUCED FAT CHOCOLATE

(71) Applicant: Cargill, Incorporated, Wayzata, MN (US)

(72) Inventors: Hela BESSAIES-BEY, Metz (FR); Stephane DEBON, Saint Gilles (BE); Fabien DECLERCQ, Le Grand Madieu (FR); Janine DEOU, Meaux (FR); Nicolas ROUSSEL, Paris (FR); Paul SMITH, Waterloo (BE)

(73) Assignee: Cargill, Incorporated, Wayzata, MN (US)

(21) Appl. No.: 17/999,725

(22) PCT Filed: May 27, 2021
(86) PCT No.: PCT/US2021/034491

§ 371 Date: Nov. 23, 2022

(30) Foreign Application Priority Data
May 28, 2020 (EP) 20176979.1

(51) Int. Cl. A23G 1/36; A23G 1/50

(52) U.S. Cl. CPC A23G 1/36; A23G 1/50

(57) ABSTRACT

The present invention relates to a reduced fat chocolate composition and method of manufacturing a reduced fat chocolate composition. In particular, the present invention relates to a reduced fat chocolate composition having a maximum packing fraction greater than that of an equivalent, traditionally manufactured chocolate, whilst having substantially the same viscosity as the equivalent, traditionally manufactured chocolate, in order to provide a healthier, lower cost alternative.

### CROSS-REFERENCE TO RELATED APPLICATIONS

This application claims the benefit of European Application No. 20176979.1, filed May 28, 2020, and entitled “REDUCED FAT CHOCOLATE”, which is incorporated by reference herein in its entirety.

### FIELD OF THE INVENTION

The present invention relates to a reduced fat chocolate composition and method of manufacturing a reduced fat chocolate composition. In particular, the present invention relates to a reduced fat chocolate composition having a maximum packing fraction greater than that of an equivalent, traditionally manufactured chocolate, whilst having substantially the same viscosity as the equivalent, traditionally manufactured chocolate, in order to provide a healthier, lower cost alternative.

### BACKGROUND

There is an increasing preference amongst consumers for “healthier” food products, including chocolate products, containing less fat and/or calories than conventional food products. This has created a high demand for reduced fat and reduced calorie alternatives.

The fat in chocolate typically comprises or consists of cocoa butter, and this is usually the most expensive of all chocolate ingredients. Conventional, full-fat, chocolate typically contains at least 23 wt % total fat content but this may vary significantly depending on the chocolate application. By reducing the amount of cocoa butter used to make a chocolate product, manufacturers can make a cost saving. However, it is challenging to reduce the amount of fat without negatively impacting the rheological and/or sensory (e.g. mouthfeel) properties of the chocolate.

The viscosity of chocolate is key to the intended application. Generally speaking, the less fat a chocolate contains, the thicker and more viscous the molten chocolate will be. This may be suitable for extrusion applications, for example, but unsuitable for enrobing or moulding applications as it will be difficult to process. For instance, it is mechanically difficult to apply a thin coating of chocolate to a confectionery product if the chocolate is too thick, and air bubbles may not rise from a viscous chocolate before setting occurs, thereby negatively affecting the appearance and texture of the finished product.

Emulsifiers and/or surfactants are commonly added to chocolate to enhance the rheological properties. These emulsifiers help to coat the solid particles in chocolate to allow them to flow, thereby allowing a partial reduction in fat content as the emulsifier will fulfil some of the function of the fat. However, the amount of emulsifier that can be used is limited. Higher dosages of emulsifiers can cause off-flavours and difficulties in processing the chocolate. There are also legal restrictions on the amount of emulsifiers that can be used in some jurisdictions. Some examples of emulsifiers typically used in chocolate are lecithin produced from soya, sunflower or rapeseed, ammonium phosphatide and poly glycerol poly ricinoleic acid (PGPR). Emulsifiers may also be selected, for example to produce special shaped sweets or to reduce the formation of the white mould-like spots on chocolate known as chocolate bloom.

Chocolate is a dispersion of solid particles (e.g. sugar, milk powders, and cocoa solids) in a continuous fat phase. The effect of the particle size distributions of these solid particles on the rheological characteristics of chocolate has been studied previously. For example, EP1061813 discloses rheologically modified confectionaries that have a total fat content of 16 to 35%, produced by employing particular particle size distributions. The objective in EP1061813 was to improve the packing density of the solid particles. However, the particle packing achieved was in fact poor as the authors failed to take intrinsic features such as particle shape into account. The maximum packing fraction, as determined by the methods described herein, of the product described in EP1061813 is only around 0.54 (see example 3 herein). This means that there would still be large spaces between the solid particles that are filled with expensive cocoa butter. As a result, the chocolate described therein is not cost effective to produce and would have poor rheological characteristics.

There remains a need for reduced fat chocolate that provides a healthier, lower cost alternative to traditional full-fat chocolate, and which avoids or ameliorates the aforementioned disadvantages. The present invention seeks to fulfil this need by tuning the morphological parameters of the solid particles in chocolate to allow for a decrease in fat content by increasing the solid phase volume, whilst accurately controlling the rheological behavior of the chocolate. The compositions and methods described herein can be used to produce chocolate compositions suitable for a variety of applications. The composition of the present invention has similar rheological properties to an equivalent conventional chocolate composition, whilst providing an advantageous reduction in fat and calories and reducing manufacturing costs.

### STATEMENTS OF INVENTION

In one aspect, the present invention provides a reduced fat chocolate composition comprising:

a continuous fat phase, said fat phase comprising a fat and an emulsifier; and

at least two particulate materials distributed throughout said fat phase;

wherein the at least two particulate materials have different D50 particle sizes to each other, said difference being a factor of 6-8.

The reduced fat chocolate composition may have a solid phase volume x, and a Bingham plastic viscosity value y in Pa·s at 40° C. or above, where:

x is from 0.4 to 0.7; and

y<264x³−330x²+141x−20.

The reduced fat chocolate composition may have a Bingham plastic viscosity value of between 0.1 and 10 Pa·s and a Bingham yield stress of between 1 and 150 Pa, at 40° C.

The total fat content of the reduced fat chocolate composition may be 31-33% for a moulding application, 25-27% for an extrusion application, 37-40% for an enrobing application, or 44-46% for an ice cream dipping application.

In another aspect, the present invention provides a food product comprising a reduced fat chocolate composition according to the invention.

In a further aspect, the present invention provides a method of preparing a reduced fat chocolate composition, the method comprising:

(a) providing an initial chocolate composition comprising
a continuous fat phase, said fat phase comprising a fat and an emulsifier; and at least two particulate materials distributed throughout said fat phase;

(b) optionally measuring the maximum packing fraction and viscosity of the initial chocolate composition; and

(c) preparing a reduced fat version of the initial chocolate composition by:

i. determining optimized particle packing parameters for the at least two particulate materials of the initial chocolate composition, wherein the optimized particle packing parameters are optimized such that the reduced fat chocolate composition has a maximum packing fraction value that is greater than the maximum packing fraction value of the initial chocolate composition and a viscosity that is substantially identical to the viscosity of the initial chocolate composition;

ii. selecting for the reduced fat chocolate composition at least two particulate materials that are identical to the at least two particulate materials of the initial chocolate composition but for having the optimized particle packing parameters; and

iii. combining the selected particulate materials with a fat phase and emulsifier that are identical to the fat phase and emulsifier of the initial chocolate composition to provide a reduced fat version of the initial chocolate composition.

The particle packing parameters may include particle size distribution, particle shape, and/or the relative amounts of the at least two particulate materials.

The optimized particle packing parameters may be optimized such that the reduced fat chocolate composition has a maximum packing fraction that is at least 1% greater than the maximum packing fraction of the initial chocolate composition.

The optimized particle packing parameters may be determined using mathematical modelling. Preferably, the mathematical model used is the compressible packing model described herein.

In another aspect, the present invention provides a reduced fat chocolate composition obtained or obtainable by the method of the invention.

The at least two particulate materials may be selected from the group consisting of sugars, cocoa solids, milk solids, bulking agents, calcium carbonate, nutritional particles, and flavorings and/or mixtures of two or more thereof.

The fat in the fat phase may comprise or consist of cocoa butter, cocoa butter equivalents, cocoa butter alternatives, anhydrous milk fat, fractions thereof and/or mixtures of two or more thereof.

The emulsifier may be selected from the group consisting of: lecithin, soy lecithin, polyglycerol polyricinoleate (PGPR), ammonium phosphatide (AMP), sorbitan tristearate, sucrose polyerucate, sucrose polystearate, phosphated mono-di-glycerides/diacetyl tartaric acid of mono glycerides.

### BRIEF DESCRIPTION OF FIGURES

FIG. 1 is a graph showing the relationship between viscosity and solid phase volume for a generic solution.

FIG. 2 is a graph showing the relationship between viscosity and solid phase volume for formulation 1 (prior art), and formulations 2 and 3 (in accordance with the invention) for different chocolate applications: extrusion, moulding, enrobing, and Ice cream.

FIG. 3 is a graph showing the relationship between viscosity and ϕ/ϕₘₐₓ for formulation 1 (prior art), and formulations 2 and 3 (in accordance with the present invention) for different chocolate applications: extrusion, moulding, enrobing, and Ice cream.

FIG. 4 is a PGPR flow curve for dark chocolate samples.

FIG. 5 is a PGPR flow curve for milk chocolate samples.

FIG. 6 is a representation of the (a) loosening and (b) wall effects taken into account in the compressible packing model (CPM).

FIG. 7 is a graph showing the evolution of the virtual maximum packing fraction of a binary mixture.

FIG. 8 is a graph showing the particle size distribution of a typical cocoa powder having a maximum packing fraction of 0.49.

FIG. 9 is a series of two graphs (a) and (b) describing maximum packing fraction as a function of (a) the shape coefficient β (b) the aspect ratio of particles. The particle size distribution is maintained constant (shown in FIG. 8).

FIG. 10 is a graph showing % reduction in fat in accordance with the invention.

FIG. 11 is a graph showing % reduction in fat in accordance with the invention.

FIG. 12 is graph showing the correlation between viscosity and ϕ/ϕₘₐₓ for known chocolates manufactured by Cargill.

### DETAILED DESCRIPTION

Unless otherwise specified, all terms should be accorded a technical meaning consistent with the usual meaning in the art as understood by the skilled person.

All ratios, amounts, and percentages in the present description are relative to the total weight of the reduced fat chocolate composition, unless otherwise specified.

All parameter ranges include the end-points of the ranges and all values in between the end-points, unless otherwise specified.

When used in these specification and claims, the terms “comprises” and “comprising” and variations thereof mean that the specified features, steps or integers are included. The terms are not to be interpreted to exclude the presence of other features, steps or components.

### Chocolate Composition

The present invention provides a method of preparing a reduced fat chocolate composition. As used herein, the term “chocolate composition” refers to any composition comprising cocoa solids (as defined below) in any amount, notwithstanding that in some jurisdictions chocolate may be legally defined by the presence of a minimum amount of cocoa solids and/or compounds that comprise cocoa butter or cocoa butter substitutes. Advantageously, the term chocolate composition refers to a composition that meets a legal definition of chocolate in any jurisdiction (preferably the US and/or EU) and also includes any product (and/or component thereof) in which all or part of the cocoa butter is replaced by cocoa butter equivalents, replacers, or substitutes. The term chocolate composition may also refer to chocolate compositions comprising cocoa butter and edible solids other than cocoa solids and to “chocolate-like” compositions comprising a suspension of edible solids in a continuous fat phase other than cocoa butter (e.g. Caramac®). The term chocolate composition may refer to an entire food product and/or a component thereof. The chocolate may be a dark, milk, white, ruby, or crumb chocolate, or variants thereof known to the person skilled in the art. The chocolate composition may be suitable for various applications, including but not limited to extrusion, moulding, enrobing, coating, dipping (e.g. for dipping ice-cream), spraying, making chocolate bars, chunks, chips, crumbs, vermicelli and/or sprinkles.

The reduced fat chocolate composition has a reduced fat content relative to an initial chocolate composition.

The initial chocolate composition is the starting material for the method of the invention and may comprise any existing chocolate composition as defined above, which may be commercially available or purpose-made. The objective of the method is to obtain a reduced fat chocolate composition that can be used as a lower fat alternative to the initial chocolate composition.

The reduced fat chocolate composition that is obtained or obtainable by the method of the present invention comprises at least two particulate materials dispersed throughout a continuous fat phase, and an emulsifier. In molten form, the particulate materials are suspended in the fat phase of the composition, which is in a liquid state. Preferably, the particulate materials are distributed substantially homogenously throughout the fat phase.

### Fat Phase

The fat phase of the reduced fat chocolate composition may comprise any fat which is suitable for chocolate making, including, but not limited to cocoa butter, cocoa butter alternatives (including equivalents, replacers, and substitutes), vegetable fats, anhydrous milk fat, fractions thereof and/or mixtures of two or more thereof. The fat phase also comprises one or more emulsifiers. Preferably, the fat phase consists of a fat or fats suitable for chocolate making and one or more emulsifiers.

Non-limiting examples of suitable emulsifiers are lecithin, soy lecithin, polyglycerol polyricinoleate (PGPR), ammonium phosphatide (AMP), sorbitan tristearate, sucrose polyerucate, sucrose polystearate, phosphated mono-di-glycerides/diacetyl tartaric acid of mono glycerides, or combinations thereof.

Preferably, the fat phase comprises cocoa butter. This cocoa butter in the fat phase is also referred to herein as “added cocoa butter” or “added fat” to distinguish it from cocoa butter that may be intrinsic to some cocoa solid containing ingredients as discussed below.

In one non-limiting example, the added cocoa butter is present in the chocolate composition in an amount of from 0% to 40% by mass relative to the total mass of the chocolate composition. Preferably, from 5% to 35%, more preferably from 10% to 30%, more preferably from 15% to 25%.

The total fat content of the reduced fat chocolate composition comprises added fat in the fat phase as well as any fat that may be part of the particulate ingredients (e.g. in full-fat cocoa powder). The total fat content of the reduced fat chocolate composition according to the present invention is up to 20% less than the total fat content of the initial chocolate composition, for example up to 15% less, or up to 10% less, or up to 5% less. In other examples the total fat content of the reduced fat chocolate composition according to the present invention is between 0.5% to 10% less than the fat content of the initial chocolate composition, or from 1-3% less than the fat content of the initial chocolate composition. The total fat content of the reduced fat chocolate composition according to the present invention may be 20% or more, relative to the total weight of the reduced fat chocolate composition, whilst still being less than the total fat content of the initial chocolate composition. In one (non-limiting) example of a chocolate bar product according to the invention the total fat content is 26% or less, preferably 25% or less, more preferably 24% or less.

### Particulate Materials

The reduced fat chocolate composition comprises at least two particulate materials, which are distributed (e.g. homogeneously) throughout a fat phase.

The at least two particulate materials are selected from the group consisting of sugars, cocoa solids, milk solids, bulking agents, calcium carbonate, nutritional particles (e.g. vitamins, minerals, and/or nutraceutical compositions), flavourings (e.g. vanilla, spices, coffee, salt, etc.), non-visible inclusions, and/or any other edible solid particles suitable for use in confectionery, and any combination thereof.

The term “sugar” as used herein refers to any type of sweetener or sweetener containing formulation which is suitable for use in food. Non-limiting examples of sugars that may be used in the present invention include monosaccharides, such as glucose, dextrose, fructose, allulose or galactose; disaccharides such as sucrose, lactose or maltose; polyols such as sorbitol, mannitol, maltitol, xylitol, erythritol, or isomalt; high intensity sweeteners, such as Stevia®; honey, agave syrup, maple syrup, and combinations of two or more thereof.

Advantageously, the sugar is sucrose. The term “sucrose” as used herein includes sucrose in various forms including but not limited to standard (e.g. granulated or crystalline) table sugar, powdered sugar, caster sugar, icing sugar, sugar syrup, silk sugar, unrefined sugar, raw sugar cane, and molasses.

Advantageously, the sugar is a formulation comprising crystalline sugar dispersed in cocoa butter, hereafter referred to as “sweet fat”, prepared according to example 1 below. Sweet fat is essentially chocolate without cocoa or dairy-free white chocolate.

In one non-limiting example, the chocolate composition comprises sugar in any amount between 1% and 65% by weight relative to the total weight of the chocolate composition, for example between 5% and 60%, or between 10% and 55%, or between 15% and 50%, or between 20% and 45%, or between 25% and 40%, or between 30% and 35%. Preferably, sugar is included in an amount of from 40% to 60%, or preferably from 45% to 60%, or preferably from 50% to 55%.

As used herein, particle size (also referred to as “granulometry”) is defined using the D50 value. The D50 value is a common method of describing particle size distribution, and is sometimes referred to as the “average” or “mean” particle size. “D50” refers to the value of the maximum particle dimension (for example, the diameter for a generally spherical particle) where 50% of the volume of the particles in the sample have a maximum particle dimension below that value. In other words, in a cumulative distribution of the maximum particle dimension in a sample of particles, 50% of the distribution lies below the D50 value.

“Maximum dimension” or “maximum particle dimension” refers to the longest cross-sectional dimension of any particular particle, e.g. a cocoa solid particle or particle of sugar.

The D50 value may be measured using the method described herein using a laser light diffraction/scattering particle size analyser (e.g. Malvern Mastersizer 3000 as sold by Malvern Panalytical Ltd.), or using other known methods.

The sugar used in the present invention may be “coarse sugar” having a D50 particle size of greater than 50 μm, or it may be “fine sugar” having a D50 particle size of from 1 μm to 15 μm, or preferably from 7 μm to 13 μm, or preferably from 8 μm to 12 μm, or preferably around 10 μm. In a preferred embodiment, the fine sugar is sugar in the form of sweet fat (as defined above) having a D50 particle size of between 9 μm and 11 μm. In some examples, the sugar may have a bimodal particle size distribution. In that case, the D50 values above may apply to only one of the distributions.

“Cocoa solids”, as used herein, refers to solid cocoa particles. Preferably, the cocoa-solids used will be cocoa powder or a cocoa solids containing ingredient such as cocoa liquor or cocoa mass. In the case of such cocoa solids containing ingredients, the term cocoa solids refers only to the solid cocoa particles and not any surrounding fat that may also be present in the ingredients. Preferably, the cocoa solids are standard cocoa powder (with 10-12% fat content), reduced fat or de-fatted cocoa powder (e.g. produced using solvent extraction), or cocoa liquor.

In one non-limiting example, cocoa solids may be present in the reduced fat chocolate composition in an amount of from 5% to 40% by mass relative to the total mass of the chocolate composition, or preferably from 15% to 25% by mass, or preferably around 20% by mass.

The cocoa solids may be “coarse cocoa solids” having a D50 particle size of from 5 μm to 15 μm, or preferably, from 7 μm to 13 μm, or preferably from 8 μm to 12 μm, or preferably around 10 μm. Alternatively, the cocoa solids may be “fine cocoa solids” having a D50 particle size of from 0.5 μm to 4 μm, or preferably from 1 to 3 μm, or around 2 μm. In some examples, the cocoa solids may have a bimodal particle size distribution. In that case, the D50 values above may apply to only one of the distributions.

Fine sugars and/or fine cocoa solids may be available commercially or they may be produced in a pre-step of the claimed method by applying known processes such as milling, micronizing, or similar to coarse sugar or cocoa solids.

“Bulking agent(s)”, also known as “fillers”, may be used as a particulate material to influence the organoleptic or rheological properties of the chocolate composition. Any suitable bulking agent known in the art may be used in accordance with the present invention, including soluble and/or insoluble fibres. Non-limiting examples of “insoluble fibre” that may be used in accordance with the present invention are dietary fibres, cereal fibres and/or other plant fibres. Non-limiting examples of “soluble fibre” that may be used in accordance with the present invention are resistant dextrin, resistant/modified maltodextrin, polydextrose, β-glucan, galactomannan, fructo-oligosaccharides, gluco-oligosaccharide, galacto-oligosaccharides, MOS (mannose-oligosaccharides, also known in the art as mannan-oligosaccharides or manno-oligosaccharides), pectin, psyllium, inulin, and resistant starch.

According to the present invention, the at least two particulate materials have different D50 particle sizes to each other. Preferably, the difference is a factor of 3-12, preferably a factor of 5-10, more preferably a factor of 6-8, more preferably a factor of 7. In one example, the D50 particle size of the larger of the at least two particulate materials is at least 7 times greater than the D50 particle size of the smaller of the at least two particulate materials. In another example, the D50 particle size of the largest of the at least two particulate materials is at least 7 times greater than the D50 particle size of the smallest of the at least two particulate materials. Where three or more particulate materials are present in the chocolate composition the difference between the D50 particle size of each of the three or more particulate materials is at least a factor of 7.

Preferably, the at least two particulate materials are selected from the group consisting of sugars and cocoa solids. Where sugars and cocoa solids are present, the sugar particles and cocoa solids may have a different D50 particle size to each other. Alternatively or additionally, the cocoa solids and/or sugar may have a bimodal particle size distribution. In one non-limiting example the first particulate material is coarse sugar, and the second particulate material is fine cocoa solids, or a mixture of fine cocoa solids and coarse cocoa solids. In an alternative non-limiting example, the first particulate material is coarse cocoa solids and the second particulate material is fine sugar, or a mixture of fine sugar and coarse sugar. In another non-limiting example, the first particulate material is coarse cocoa solids contained in cocoa liquor (D50 approximately 10 μm) and the second particulate material is fine cocoa solids contained in cocoa liquor (D50 approximately 1-2 μm). In an alternative non-limiting example, the first particulate material is coarse cocoa powder (D50 approximately 10 μm) and the second particulate material is fine cocoa solids contained in cocoa liquor (D50 approximately 1-2 μm). In another non-limiting example, the first particulate material is coarse cocoa solids contained in cocoa liquor (D50 approximately 10 μm) and the second particulate material is coarse sugar (D50 approximately 50 μm). In another non-limiting example, the first particulate material is coarse cocoa powder (D50 approximately 10 μm) and the second particulate material is coarse sugar (D50 approximately 50 μm).

### Relationship Between Maximum Packing Fraction and Viscosity

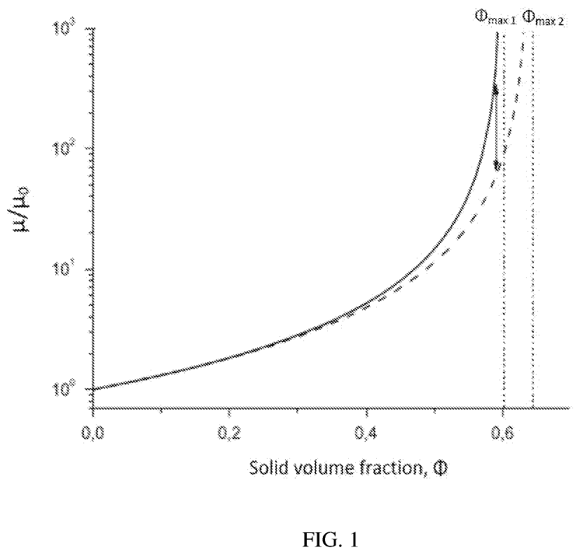

Molten chocolate is a non-dilute suspension where particles are dispersed in a Newtonian solution of fat and interact hydrodynamically, increasing the viscous dissipations. Dissipation increases with the solid phase volume (Φ) and diverges as the solid phase volume approaches the maximum packing fraction (Φₘₐₓ) (also referred to as “maximum packing density”, “maximum packing efficiency”, or “maximum packing volume”) as illustrated in FIG. 1.

“Viscosity” as used herein refers to plastic viscosity, which is a standard parameter used in the chocolate making industry. Plastic viscosity is a measure of how easily a material flows once it has started flowing, i.e. how “thin” or “thick” the material is while it is flowing.

Viscosity of a suspension can be described by the Krieger Dougherty model, which is known in the art:

$$μ = {{μ}_{0} ( 1 - \frac{Φ}{{Φ}_{max}} )}^{- α} \qquad ( 1 )$$

where μ is the suspension viscosity, μ₀ is the viscosity of the suspending fluid (in this case the fat phase), and α is a fitted factor (set at −2 for the purposes of the present disclosure). This empirical model has the advantage of agreeing well with the theoretical predictions of Einstein at low solid phase volume and diverging as quantitatively expected when the solid phase volume tend toward the maximum packing density. This is illustrated by the solid line in FIG. 1.

As shown in equation (1) and in FIG. 1, an increase of the maximum packing density (concretely meaning that Φₘₐₓ moves from φₘₐₓ₁ to Φₘₐₓ₂) allows for a decrease of viscosity (illustrated by the arrow showing the difference between the solid and dashed line) while the solid phase volume is maintained constant. Conversely, increasing the maximum packing density allows for an increase of the solid phase volume (i.e. decreasing the fat content) without affecting the viscosity of the chocolate composition. Thus, the applicant surprisingly found that particle packing density can be manipulated and/or optimized to adjust fat content whilst controlling the rheological properties of chocolate, particularly viscosity.

### Particle Packing Parameters

For the present invention, it is desirable to have very close or dense packing of the particulate materials in the reduced fat chocolate composition, ideally approaching the highest geometrically admissible packing. The packing density is an intrinsic geometric property of a particle system and is influenced by morphological parameters including the particle size distribution and the particle shape.

Particle size distributions that are bimodal (i.e. having two arithmetic modes) or polydisperse (i.e. having more than two arithmetic modes) generally have a higher packing density than those which are monodisperse (i.e. having one arithmetic mode) because particles with variable size can more efficiently fill a given space. Simply put, the space between the coarser particles can be occupied by finer particles in a bimodal or polydisperse system, reducing the size of interstitial voids between the particles. In the context of present invention, the more tightly together the particles are packed, the smaller the space which can be filled by fat, thereby enabling a reduction in the total fat content.

To optimize particle packing, the particle size distribution of a system must be controlled. Whilst it may be theoretically possible to optimize the particle packing of a simple composition experimentally by mixing different proportions of particles having various particle size distributions using trial and error, this is not practically possible for a complex multi-component system such as chocolate.

Particle shape can also affect particle packing. For example, spheres do not arrange themselves in the same way as cubes, crushed aggregates, or fibres. Previous research has shown that particles with regular shapes and flat surfaces locally arrange themselves better than those with irregular shapes. Particles with a rounder, smoother shape, also generally have higher packing density than particles with a rough surface.

The method of the invention involves determining optimal particle packing parameters for the particulate materials in the initial chocolate composition. The particle packing parameters may include particle size distribution, particle shape, and/or the relative amounts of the at least two particulate materials. This determination involves analyzing the particulate materials in the initial chocolate composition system and calculating or predicting the optimal particle packing parameters for those particulate materials.

This determination of optimal particle packing parameters may be performed using mathematical modelling. For example, variables in the system may be manipulated in a theoretical model to ascertain the effect on the maximum packing fraction, whilst controlling the viscosity parameter. The optimal particle packing parameters are those that result in the highest maximum packing fraction that is theoretically possible.

Unlike models that have been used previously (e.g. in EP1061813) the maximum packing fraction calculation adopted by the inventors, e.g. CPM described below, takes into account both the particle size distribution and the shape of the particles to estimate the packing density. This enables much closer particle packing to be achieved in the reduced fat chocolate product.

### Compressible Packing Model (CPM)

Preferably, the mathematical model used is the compressible packing model (CPM) developed by Francois de Larrard, which is described in Gonçalves, E. V.; Lannes, S. C. d. S Food Sci. Technol. 2010, 30, 845-851 and also described in Larrard, F. Concrete Mixture Proportioning: a scientific approach, E&FN SPON: An imprint of Routledge, London and New-York, 1999. ISBN 0 419 23500 0 (which is incorporated herein by reference in its entirety). This model takes into account both the particle size distribution and the shape of the particles to estimate the maximum packing fraction. CPM is a semi-empirical model developed to describe the packing density achieved by a granular mixture namely concrete. The main principle of the model is that all size classes in the mixture interact with all other sizes classes in the mixture affecting the overall packing density. The model also assumes that for the same material, the shape of a particle is independent on the size classes. The shape coefficient is computed by taking into account the particle size distribution and the maximum packing fraction of each material.

The inventors unexpectedly found that the CPM, which was initially developed for concrete-based materials, can be used to predict and optimize the maximum packing fraction of sugar and cocoa particles. They found that the predicted (by CPM) and measured (by centrifugation measurement method 1 below) maximum packing fractions of different cocoa/sugar mixtures as a function of their composition are equal.

Compressible Packing Model (CPM) is actually an improvement of an old model developed by de Larrard and Storvall in 1986 called the Linear Packing Model (LPM). What makes CPM a better packing model than LPM is the fact that it takes into account a packing index K, which depends on the experimental protocol packing. This index corresponds to the energy used to pack experimentally a system and therefore it makes it possible to have a predictive packing density that is representative of the real one measured experimentally. CPM allows to predict two type of packing namely the real maximum packing fraction and the virtual maximum packing fraction. The real maximum packing fraction corresponds to what is known as random close packing (i.e., the packing of particles under a given amount of compaction energy), which itself corresponds to the experimental maximum packing fraction called Øₘₐₓ described herein. In the following, Ø_{max predicted} will refer to the real maximum packing fraction predicted by CPM and Øₘₐₓ to real maximum packing fraction measured experimentally. The virtual maximum packing fraction as defined by de Larrard represents the highest maximum packing fraction that can be attainable for a given mixture considering that there is a perfectly ordered packing (i.e., each particle is placed one by one near to each other). It corresponds to what is known as ordered packing density and we will refer to it as Øᵥᵢᵣₜᵤₐₗ. In CPM, the real maximum packing fraction predicted (Ø_{max predicted}) is obtained from the virtual maximum packing fraction (Øᵥᵢᵣₜᵤₐₗ) thanks to the packing index K. Another important parameter that CPM takes into account are the particulate interactions generally occurring when two or more powders are mixed together. De Larrard refers to these particulate interactions as geometrical interactions. They defined three possible geometrical interactions and concluded that the most common one is what is called the partial interaction. This interaction can be defined as the interaction occurring between two particles having different size diameters not so far from each other. In the following, we will only focus on binary and polydisperse mixtures whose particles interact partially to describe how the virtual maximum packing fraction and the predicted real maximum packing fraction are calculated in CPM.

The prediction of the virtual maximum packing fraction (Øᵥᵢᵣₜᵤₐₗ) for a given mixture depends on the particle size distribution by volume (i.e., each size class and its corresponding volume fraction) of each of its components, their experimental maximum packing fraction (Øₘₐₓ), the experimental packing index K, and the geometrical interactions occurring between the particles.

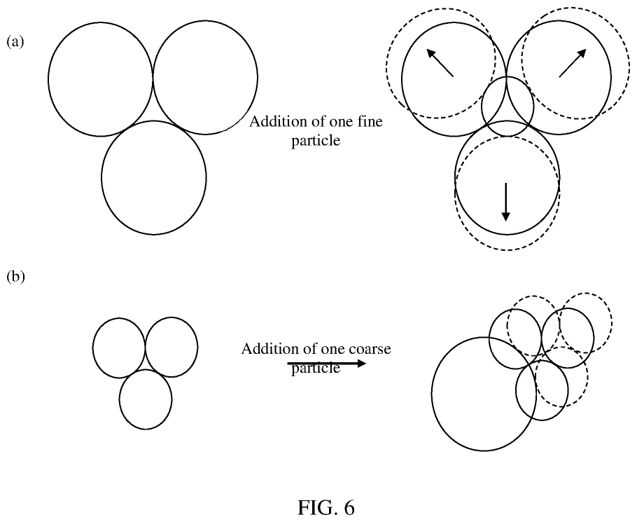

Let's take the example of a binary mixture composed of component 1 (coarse particles) and component 2 (fine particles) to demonstrate how CPM works. Component 1 and 2 have respectively d₁ and d₂ as particle diameters. CPM assumes that there is at least one dominant diameter in such mixture. Therefore, two different configurations can be distinguished. In the first configuration, the coarse particles diameter is dominant. When one fine particle is inserted into the coarse particles packing, and if the fine particle is not small enough to fill the space between the coarse particles, there is a loosening of the coarse particles packing which induces a de-structuring of the latter. This de-structuring phenomenon is usually referred as “loosening effect” (FIG. 6(a)). In the second configuration where the fine particles dominate, when one coarse particle is inserted into the fine particles packing, an increase of the porosity in the vicinity of its surface is observed, leading to another kind of de-structuring phenomenon called “wall effect” (FIG. 6(b)). Both effects depend on the geometrical interactions between particles of different size and are considered a linear function of the maximum packing fraction of the dominant component.

In the following, we are detailing how de Larrard includes the effects described above in the virtual maximum packing fraction calculation by studying the same binary system than previously (with d₁≥d₂) and in which partial interaction between particles arise. In de Larrard's approach, the virtual maximum packing fraction of a binary mixture can be defined as:

Øᵥᵢᵣₜᵤₐₗ=Ø₁+Ø₂

where Ø₁ and Ø₂ are the partial volumes (i.e., the volume occupied by each component taking into account the presence of the other component). In the following, y₁ and y₂ represent the volume fractions of component 1 and 2 respectively. β₁ and β₂ represent the residual packing fractions of each component taken separately.

By definition:

$${y}_{1} = \frac{{∅}_{1}}{{∅}_{1} + {∅}_{2}} \\ {y}_{2} = \frac{{∅}_{2}}{{∅}_{1} + {∅}_{2}} \\ {y}_{1} + {y}_{2} = 1$$

When there is a partial interaction between particles, a loosening effect will happen when the coarse particles are dominant while a wall effect will be observed when the fine particles are dominant Therefore, to calculate the virtual maximum packing fraction, the loosening and wall effects coefficients (a_{1,2} and b_{1,2} respectively) are taken into account.

The loosening effect leads to a decrease of the partial volume Ø₁ due to the presence of fine particles. And as said previously, this effect is a linear function of the partial volume Ø₂ because we supposed that the fine particles are sufficiently distant from each other. So, in this case, the virtual maximum packing fraction Øᵥᵢᵣₜᵤₐₗ equals to:

$${∅}_{virtual ( 1 )} = {∅}_{virtual} \\ {∅}_{virtual ( 1 )} = {∅}_{1} + {∅}_{2} \\ {∅}_{virtual ( 1 )} = {β}_{1} ( 1 - {a}_{1 , 2} {∅}_{2} ) + {∅}_{2} \\ {∅}_{virtual ( 1 )} = {β}_{1} + ( {∅}_{1} + {∅}_{2} ) ( 1 - {a}_{1 , 2} {β}_{1} ) + {y}_{2} \\ {∅}_{virtual} = {∅}_{virtual ( 1 )} = \frac{{β}_{1}}{1 - {y}_{2} ( 1 - {a}_{1 , 2} {β}_{1} / {β}_{2} )}$$

The wall effect leads to a reduction of the volume occupied by the fine particles. Here again, we will assume that the reduction is a linear function of the real maximum packing fraction Ø_{max 1} if the coarse particles are sufficiently distant from each other. We then write:

$${∅}_{virtual ( 2 )} = {∅}_{virtual} \\ {∅}_{virtual ( 2 )} = {∅}_{1} + {∅}_{2} \\ {∅}_{virtual ( 2 )} = {∅}_{1} + {β}_{2} ( 1 - \frac{{∅}_{1}}{1 - {∅}_{1}} {b}_{1 , 2} ) ( 1 - {∅}_{1} ) \\ {∅}_{virtual ( 2 )} = {β}_{2} + {y}_{1} ( {∅}_{1} + {∅}_{2} ) ( 1 - {β}_{2} ( 1 + {b}_{1 , 2} ) ) \\ {∅}_{virtual ( 2 )} = \frac{{β}_{2}}{1 - {y}_{1} ( 1 - {β}_{2} + {b}_{1 , 2} {β}_{2} ( 1 - 1 / {β}_{1} ) )}$$

whatever the dominant diameter, Øᵥᵢᵣₜᵤₐₗ₍₁₎ and Øᵥᵢᵣₜᵤₐₗ₍₂₎ and may be calculated. Therefore, we can state that for any case:

Øᵥᵢᵣₜᵤₐₗ≤Øᵥᵢᵣₜᵤₐₗ₍₁₎

Øᵥᵢᵣₜᵤₐₗ≤Øᵥᵢᵣₜᵤₐₗ₍₂₎

Then:

Ø₁≤β₁

Ø₂≤β₂(1−Ø₂)

These last inequalities are called the impenetrability constraint relative to component 1 and 2 by de Larrard. Therefore, we can conclude from these previous statements, with no more concern about which component is dominant, that:

Øᵥᵢᵣₜᵤₐₗ=inf(Ø_{virtual (1)};Øᵥᵢᵣₜᵤₐₗ₍₂₎)

The boundary conditions for the coefficients a_{1,2} and b_{1,2} are:

$${a}_{1 , 2} = {b}_{1 , 2} = 0 when \frac{{d}_{2}}{{d}_{1}} ≪ 1$$

(no interaction between the particles)

$${a}_{1 , 2} = {b}_{1 , 2} = 1 when \frac{{d}_{2}}{{d}_{1}} = 1$$

(total interaction between the particles)

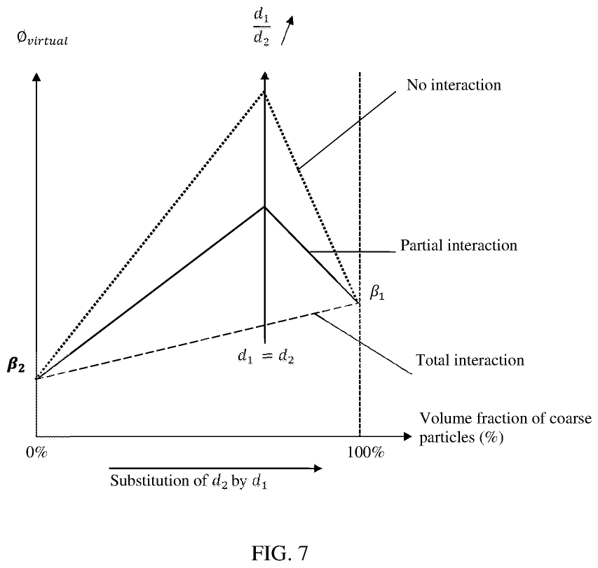

The evolution of the virtual maximum packing fraction (Øᵥᵢᵣₜᵤₐₗ) considering the particulate interactions is represented in FIG. 7. When there is no or partial interaction, the virtual maximum packing fraction increases until reaching an optimal value and then decreases. Nevertheless, we want to specify that there is not always an optimum when two or more classes are mixed together.

Let's now consider the general case of a ternary mixture in which d₁≥d₂≥d₃. Let's assume that 2 is the dominant component and that 1 exert a wall effect on those of 2 while 3 is exerting a loosening effect on 2. Therefore,

$${∅}_{v irtual} = {∅}_{1} + {∅}_{2} + {∅}_{3}$$

$${y}_{1} = \frac{{∅}_{1}}{{∅}_{1} + {∅}_{2} + {∅}_{3}}$$

$${y}_{2} = \frac{{∅}_{2}}{{∅}_{1} + {∅}_{2} + {∅}_{3}}$$

$${y}_{3} = \frac{{∅}_{3}}{{∅}_{1} + {∅}_{2} + {∅}_{3}}$$

$${y}_{1} + {y}_{2} + {y}_{3} = 1$$

If we follow the same approach as previously, we can conclude that:

$${∅}_{2} = {β}_{2} ( 1 - {a}_{2 , 3} \frac{{∅}_{3}}{1 - {∅}_{1}} - {b}_{2 , 1} \frac{{∅}_{1}}{1 - {∅}_{1}} ) ( 1 - {∅}_{1} )$$

$$Then ,$$

$${∅}_{v i r t u a l} = {∅}_{virtual ( 2 )}$$

$${∅}_{v i r t u a l} = \frac{{β}_{2}}{1 - ( 1 - {β}_{2} ( 1 + {b}_{2 , 1} ) ) {y}_{1} - ( 1 - {a}_{2 , 3} ) {y}_{3}}$$

$${∅}_{v i r t u a l} = \frac{{β}_{2}}{1 - ( 1 - {β}_{2} + {b}_{2 , 1} {β}_{2} ( 1 - 1 / {β}_{1} ) ) {y}_{1} - ( 1 - {a}_{2 , 3} {β}_{2} / {β}_{3} ) {y}_{3}}$$

Thanks to the linearity of the equations describing loosening and wall effects, we can easily generalize the equation giving the virtual maximum packing fraction for a polydisperse mixture of n components of different sizes. When i is dominant in a polydisperse mixture, the most general equation for the virtual packing fraction is:

$${∅}_{v irtual} = \frac{{β}_{i}}{1 - {\sum }_{j = 1}^{i - 1} ( 1 - {β}_{i} + {b}_{i j} {β}_{i} ( 1 - 1 / {β}_{j} ) ) {y}_{j} - {\sum }_{j = i + 1}^{n} ( 1 - \frac{{a}_{i j} {β}_{i}}{{β}_{j}} ) {y}_{j}}$$

$$With :$$

$${a}_{i j} = \sqrt{1 - {( 1 - \frac{{d}_{j}}{{d}_{i}} )}^{1.02}}$$

$${b}_{i j} = \sqrt{1 - {( 1 - \frac{{d}_{i}}{{d}_{j}} )}^{1.5}}$$

We are now considering the real packing fraction of a binary mixture. As already said, there is a packing index K which allows to deduce the real maximum packing fraction from the virtual maximum packing fraction. In de Larrard approach, the expression of the packing index K for a binary mixture is:

$$K = \frac{\frac{{y}_{1}}{{β}_{1}}}{\frac{1}{{∅}_{max predicted}} - \frac{1}{{∅}_{v i r tual ( 1 )}}} + \frac{\frac{{y}_{2}}{{β}_{2}}}{\frac{1}{{∅}_{max predicted}} - \frac{1}{{∅}_{v i r tual ( 2 )}}}$$

For a polydisperse mixture with a dominant component i, the expression of the packing index K becomes:

$$K = {\sum }_{i = 1}^{n} {K}_{i} = {\sum }_{i = 1}^{n} \frac{\frac{{y}_{i}}{{β}_{i}}}{\frac{1}{{∅}_{max predicted}} - \frac{1}{{∅}_{v i r tual ( 1 )}}}$$

For monodisperse mixture:

$$K = \frac{1}{\frac{β}{{∅}_{max predicted} - 1}}$$

In order to be able to use the CPM in a practical way, it may be programmed using Microsoft Excel™ as software. The steps of the software programming should follow the de Larrard approach which is clearly described in Gonçalves, E. V.; Lannes, S. C. d. S Food Sci. Technol. 2010, 30, 845-851. The software may then be used to determine the optimal particle packing parameters for the initial chocolate composition.

### Obtaining Optimized Particulate Materials

Once the optimal particle packing parameters for the initial chocolate composition have been determined, the manufacturer is then able to use this information to produce a reduced fat version of the initial chocolate composition which has the same type of particulate ingredients as the initial chocolate composition, but where the characteristics of the particulate materials have been selected or manipulated such that the particle packing parameters of those particulate materials conform as closely as possible to the optimal particle packing parameters previously determined.

In practice, it may not be possible to achieve the absolute optimal particle packing parameters, so we describe the particle packing parameters in the reduced fat chocolate composition as being “optimized” rather than necessarily “optimal”. Optimized should be understood to mean that the particle packing parameters are as close as practically possible to being optimal, or are absolutely optimal.

In one example, the manufacturer may select the particulate materials for the reduced fat chocolate composition by selecting the best combination of particulate materials from an available set of particulate materials taking into account their properties such as particle size distribution and particle shape. In another example, the manufacturer may manipulate available particulate materials by altering their size and/or shape using known methods (e.g. grinding, milling etc.). In either case, the objective is to obtain particulate materials that conform as closely as possible to the optimal particle packing parameters previously determined

As and when the particle packing parameters are optimized, the reduced fat chocolate composition has a maximum packing fraction that is greater than the maximum packing fraction of the initial chocolate composition and a viscosity that is substantially identical to the viscosity of the initial chocolate composition. “Substantially identical” viscosity means that the viscosity of the reduced fat chocolate composition is the same as that of the initial chocolate composition, or that it differs from that of the initial chocolate composition within an acceptable limit (e.g. ±5%) taking into account the intended application of the reduced fat chocolate composition. In other words, the reduced fat chocolate composition has a viscosity such that it is suitable for the same application as the initial chocolate composition, and can be used as a lower fat alternative, replacement, or substitute for the initial chocolate composition.

In general, it can be verified whether a given chocolate composition is a reduced fat chocolate composition produced according to the method of the invention, i.e. whether the particulate materials in the given chocolate composition are optimized in accordance with said method, because if this is so the maximum packing fraction of the given chocolate composition will closely fit the mathematical model used in said method. The maximum packing fraction of a given real-life chocolate composition may be measured using the centrifugation measurement method 1 described herein. Alternatively, if characteristics such as particle size distribution and/or shape of the particulate materials of the given chocolate composition are known, e.g. from literature, the maximum packing fraction of the given chocolate composition may be calculated mathematically by inputting said values into the CPM described above, e.g. using software. The latter is demonstrated in example 3 below.

### Exemplary Values for Maximum Packing Fraction, Viscosity, and Yield Stress

Generally speaking, the lower the maximum packing fraction, the higher the fat content of a chocolate composition. A low maximum packing fraction implies that there is a high amount of fat in the system resulting in the manufacture being inefficient and expensive. The present invention allows for the manufacture of chocolates having a higher maximum packing fraction than that of the initial chocolate composition.

Normally, a high fat, well packed (high maximum packing fraction) system should have low viscosity and be easy to process. If the fat content or packing density is reduced, then the system will have higher viscosity and become harder to process. The applicant has surprisingly found that the fat content can be reduced whilst maintaining the same viscosity when selecting ingredients to achieve the maximum packing fraction calculation.

The maximum packing fraction of the reduced fat chocolate composition obtained by the method of the present invention is greater than that of the initial chocolate composition. Preferably, the maximum packing fraction of the reduced fat chocolate composition obtained by the method of the present invention is at least 1% greater than that of the initial chocolate composition, or more preferably at least 3% greater than the maximum packing fraction of the initial chocolate composition. In non-limiting examples, the maximum packing fraction of the reduced fat chocolate composition is greater than or equal to 0.60, 0.61, 0.62, 0.63, 0.64, 0.65, 0.66, 0.67, 0.68, 0.69, 0.70, 0.71, 0.72, 0.73, 0.74, or 0.75.

Due to the correlation between maximum packing fraction and viscosity as detailed above with reference to FIG. 1, and the importance of viscosity for chocolate processing, the desired maximum packing fraction of the reduced fat chocolate composition may depend on the eventual application of the chocolate composition. For example, the ideal maximum packing efficiency of a chocolate composition for an extrusion application will be different (e.g. higher) than the maximum packing fraction for a chocolate for an enrobing application. For example, the maximum packing fraction may be greater than or equal to 0.72 for extrusion applications, greater than or equal to 0.63 for moulding applications, greater than or equal to 0.64 for enrobing applications, or greater or equal to 0.66 for frozen confectionery applications. The Bingham viscosity value for the reduced fat chocolate composition is between 0.1 to 10 Pa·s. For example, the viscosity may be between 1 and 9 Pa·s, between 2 and 8 Pa·s, between 3 and 7 Pa·s, or between 4 and 6 Pa·s at 40° C.

Viscosity can be measured with the Bingham plastic model. The Bingham plastic model is a two-parameter rheological model widely used to describe the flow characteristics of many types of fluid. It can be described mathematically as follows:

τ=τ₀+μ\dot{γ}

### With:

τ: Shear stress (Pa)
τ₀: Yield stress (Pa)
μ: Plastic viscosity (Pa·s)
\dot{γ}: Shear rate (s⁻¹)

Plastic viscosity is a parameter of the Bingham plastic model. It is the slope of the shear stress/shear rate line above the yield stress.

Yield stress is the minimum stress that should be overcome to initiate flow from rest. The Bingham yield stress of the reduced fat chocolate composition of the invention is between 1 and 150 Pa at 40° C. For example, the yield stress is between 20 and 130 Pa, or between 40 and 110 Pa, or between 60 and 90 Pa.

The measurement method for viscosity and yield stress is provided in measurement method 2 below.

The chocolate composition of the invention has a solid phase volume x, and a Bingham plastic viscosity value y in Pa·s at 40° C. or above, where:

x is from 0.4 to 0.7; and

y<264x³−330x²+141x−20.

“Solid phase volume” as used herein, refers to the ratio of the total volume occupied by the particulate materials to the total volume of the molten chocolate composition, which in turn is the sum of the volumes of the solid phase (i.e. particulate materials) and the fat phase.

### Method of Manufacture

In one example, the method of the present invention involves selecting, i.e. actively choosing, at least two particulate materials from amongst available particulate materials, that have optimized particle packing parameters as described above. The choice of particulate materials is thus driven by mathematical modelling to optimise the particle packing density as described above. It is important that the at least two particulate materials selected have different average particle sizes in order to enhance packing density.

Since the objective of the method is to produce a reduced fat version of an initial chocolate composition, the ingredients (i.e. the particulate materials, fat and emulsifier) selected for use in the reduced fat chocolate composition will be of the same type as the ingredients used in the initial chocolate composition except that the particle packing parameters of the particulate materials will be different (optimized). For example, if the initial chocolate composition comprises cocoa solids, sugar, cocoa butter and PGPR, then the reduced fat chocolate composition will also contain cocoa solids, sugar, cocoa butter, and PGPR, but the difference is that the cocoa solids and sugar are particularly selected such that the particle packing parameters are optimized.

In another example, the method of the present invention involves manipulating one or more available particulate materials, e.g. by changing their particle size distribution and/or particle shape, so that they possess the optimized particle packing parameters as described above. Non-limiting examples of techniques suitable for performing this manipulation include grinding or milling.

Once the at least two particulate materials have been obtained, either by selection or manipulation or both, they are combined with the fat phase and the emulsifier to form a chocolate composition using any known chocolate making techniques.

The fat and emulsifier may be combined with the particulate materials separately or simultaneously. In one example, the emulsifier is added to the particulate material/fat mixture. In an alternative example, the emulsifier is added to the fat phase prior to combining with the particulate materials. Fat may be added all at once, or in batches.

The combining preferably occurs whilst mixing.

Optionally, the particulate materials may be pre-mixed before combining with the fat phase and emulsifier.

Optionally, the particulate materials may be subjected to a refining process. This may occur at any stage of the method.

The method may also include a conching step.

### Food Product

The chocolate composition of the present invention may form all or part of a food product. The food product is preferably a confectionery product. Confectionery products are foodstuffs which are predominately sweet in flavour. Exemplary confectionery products include, but are not limited to, chocolate, chocolate-like materials, fat-continuous filling materials, frozen confectioneries (such as ice cream), chocolate pieces within a frozen confectionery, baked goods such as biscuits, cakes, breads, and pastries, sweets, candies, gummies, sugar confections, tablets, treats, toffees, boiled sweets, bonbons, candy-floss, caramel, fudge, liquorice, marshmallow, nougat, truffles, fondant, ganache. The confectionery product according to the present invention may be the entire food product or it may part of a food product such as a filling, binder, shell or coating, inclusion or decoration for a food product. Any combination of the above alternatives is also encompassed by the present invention.

Preferably, the confectionery product is a chocolate product. In the context of the present invention, the term “chocolate” has the same definition as the term “chocolate composition” (see above definition).

### Measurement Methods

1. Measuring Maximum Packing Fraction

The maximum packing fraction of chocolate solids (ϕₘₐₓ) is measured by multi-step centrifugation in a deflocculated state (non-aggregating solids with frictional forces reduced to the minimum via a yield stress optimisation) using an emulsifier, PGPR.

Depending on the recipe (e.g. dark chocolate or milk chocolate), the PGPR dosage requires the measurement of the yield stress versus PGPR concentration.

ϕₘₐₓ=ϕᵢₙᵢₜᵢₐₗ(Hᵢₙᵢₜᵢₐₗ/H_{equilibrium})

where: ϕᵢₙᵢₜᵢₐₗ=V_{solid}/(V_{solid}+V_{fat})

and V_{solid} is the volume occupied by the solid particles in the suspension before centrifugation and V_{fat} is the volume occupied by the fat in the suspension before centrifugation

Hᵢₙᵢₜᵢₐₗ (also referred to as H₀) and H_{equilibrium} are defined below.

The fat in the liquid state is melted cocoa butter and may include emulsifiers and in the case of milk chocolate, fat from whole milk powder.

The solids (i.e. particulate materials) are:
for dark chocolate: sugar (sucrose), cocoa solids (from cocoa liquor)
for milk chocolate: sugar (sucrose), lactose, cocoa solids (from cocoa liquor), whole milk powder, skimmed milk powder, whey powder. Note that in the composition calculation, the fat in whole milk powder (typically 26 wt %) is deduced from the formulation mass and added to the liquid fat phase.

TABLE 1
Density of particulate materials

| Compound | Density (g/mL 2 s.f.) |
|---|---|
| Fat | 0.89 |
| Sugar | 1.59 |
| Cocoa solids fat free | 1.20 |
| Milk powder fat free | 1.34 |
| Whey powder fat free | 1.31 |

### Apparatus:

Centrifuge: Sorvall Legend XTR Thermo Fisher Scientific (or Sigma 3-16PK), the measurement temperature is 40° C. (the centrifuge is pre-warmed, see below). The rotor is TX-750 with 4 round buckets, code 7500 6308.

The round bucket accommodates a holder 7500 3638 that can accommodate 7 tubes of 50 mL that is a total of 28 tubes.
50 mL polypropylene centrifuge tubes with seal cap (VWR SuperClear).
RWD 20 Digital IKA stirrer with 4 bladed propeller 07 410 00.
Metal spatula.
Analytical balance to the nearest 0.01 g.
Plastic Pasteur pipettes.
Caliper Mitutoyo UK Ltd. (code 500-123U, model no CD-15B, serial number 287072) operating with V13GA battery.
Fan-assisted oven set at 50° C. for chocolate melting and conditioning prior centrifugation.
Fan-assisted oven set at 50° C. for melting chocolate without superfines, set at 60° C. for melting milk chocolate with superfine, set at 80° C. for melting dark chocolate with superfine.
Fine marker pen
Calibrated thermocouple (0.1° C. digital reading)

### Materials:

Cocoa butter in the liquid state used for temperature control in the oven and in the centrifuge).
PGPR (stored at 50° C.).

### Chocolate Melting Method:

For regular chocolate, 50° C. melting overnight is sufficient.

For chocolate with superfine particulates, the dark chocolates are melted overnight at 80° C. and the milk chocolates are melted overnight at 60° C.

After melting, the contents are mixed thoroughly with a RWD 20 Digital IKA stirrer with 4 bladed propeller set at 840 rpm for 5 minutes to ensure that all the particles are randomly and homogeneously dispersed.

From the ϕ₀ based on proximate composition (see definition of ϕ₀ in the next section), and the target ϕ₀, liquid fat needs to be added or removed, taking into account the PGPR dosing (PGPR is considered as fat).

To ensure sufficient sample for Phi max, rheology and PSD, prepare the molten chocolate on a mass scale that is sufficient for 3 centrifuge tubes of 50 mL (filling level ˜45 mL).

### Chocolate Composition and ϕ₀:

The target ϕ₀ is at least 0.53 for both dark chocolate and milk chocolate because it was found that 0.53 is the value above which the system does not segregate into layers of different particle sizes.

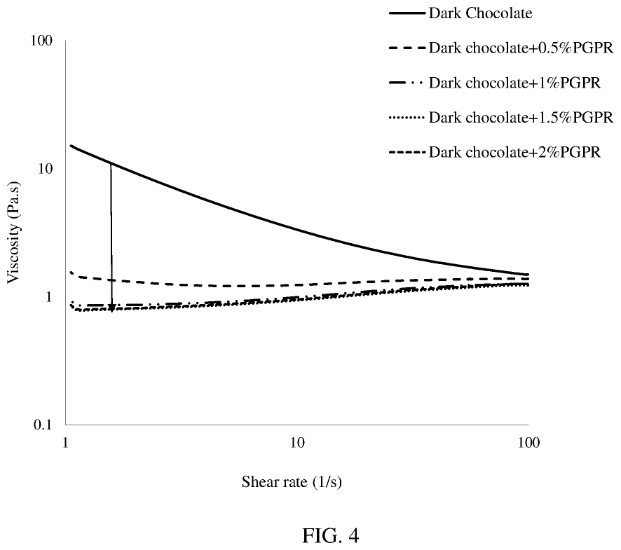

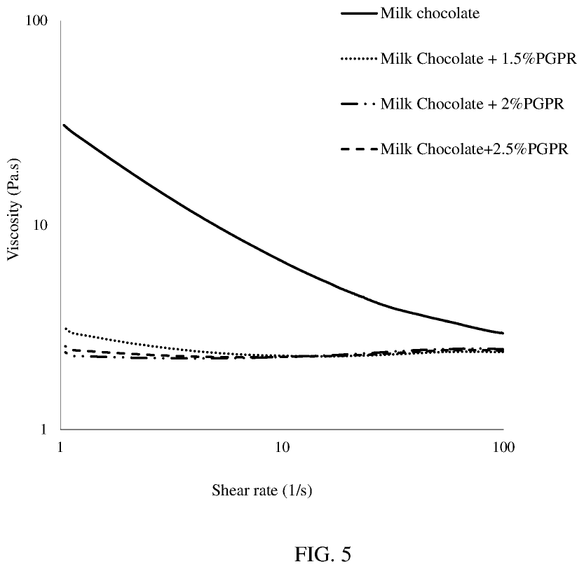

The PGPR optimal dosage is determined using a flow curve (at 40° C.). Different proportions of PGPR are added to the samples and viscosity and yield stress are measured to obtain a flow curve. The proportions of PGPR added range from 0 to 2.5% (with an increment of 0.5%) per total mass of solid particles. The proportion of PGPR at which the yield stress is the lowest, is the dosage used to deflocculate the sample in order to determine the maximum packing fraction. Without wishing to be bound by theory, the minimum yield stress is used because it corresponds to the yield stress at which the sample is deflocculated, meaning that there is no interaction between the particles. At minimum yield stress, the sample can be considered entirely deflocculated and to measure the maximum packing fraction the system must be in a deflocculated state. Exemplary PGPR flow curves for dark chocolate and milk chocolate respectively are shown in FIGS. 4 and 5.

The optimum PGPR dosage, where the yield stress is at minimum, was found to be 1.5% of total solids for dark chocolate and 2.0% of total solids for milk chocolate.

Depending on the chocolate composition, the initial ϕ₀ can be higher or lower than the target ϕ₀, in order words, fat may need to be added or removed.

When fat needs to be removed the samples are centrifuged for approximately 1 hour at 4500 rpm. The fat is removed, the PGPR added and the contents are thoroughly mixed with a mixer to give a fluid smooth slurry that is analyzed directly (no incubation needed) for ϕₘₐₓ.

Illustration 1: Dark chocolate: Noir 58 HC5738 AA00 with

Sugar 40.84 w %

Cocoa mass 43.96 w % (composed of 54 w % fat and 46 w % cocoa solids)

Cocoa butter 15.20 w %

TABLE 2
Calculation of PGPR dosage in the initial state
Initial state Φ₀ < 0.53

| | Mass m (g) per | Volume | Solid Phase |
|---|---|---|---|
| Compound | 100g | m/d (mL) | volume |
| Fat | 15.20 + | 43.55 | 0.505 |
| | (43.96 × 0.54) = | | |
| | 38.94 | | |
| Sugar | 40.84 | 25.76 | 0.495 |
| Cocoa solids | (43.96 × 0.46) = | 16.85 | (initial Φ₀) |
| | 20.22 | | |
| Solids | 61.06 | 42.61 | |
| total | 100.00 | 86.16 | 1.000 |

TABLE 3
Calculation of PGPR dosage in the final state
Initial state Φ₀ < 0.53

| | Mass m (g) | Volume | Solid Phase |
|---|---|---|---|
| Compound | per 100 g | m/d (mL) | volume |
| Fat(including | 33.79 | (42.61/0.53) × | 0.47 |
| PGPR) | | 0.47 = 37.79 | |
| Sugar | 40.84 | 25.76 | 0.53 |
| Cocoa solids | 20.22 | 16.85 | (target Φ₀) |
| Solids | 61.06 | 42.61 | |
| total | 94.85 | (42.61/0.53) | 1.000 |
| | | 80.40 | |

Per 100 g total mass in the initial state, the quantity of total fat to remove is 5.15 g (38.94-33.79) but this includes PGPR to add that is 0.92 g (1.5%×61.06 g solids)

So 6.07 g fat is first removed after centrifugation then 0.92 g PGPR is added.

Illustration 2: Milk chocolate: Lacte Equilibre HL3435 AA00 with

Sugar 41.86 w %

Cocoa mass 10.77 w % (composed of 54 w % fat and 46 w % cocoa solids)

Cocoa butter 24.64 w %

Whole milk powder 22.73 w % (composed of 26 w % fat and 74 w % defatted milk powder)

TABLE 4
Calculation of PGPR dosage in the initial state
Initial state Φ₀ < 0.53

| | Mass m (g) | Volume m/d | Solid Phase |
|---|---|---|---|
| Compound | per 100g | (mL) | volume |
| Fat | 24.64 + (10.77 × 0.54) + | 40.67 | 0.486 |
| | (22.73 × 0.26) = 33.37 | | |
| Sugar | 41.86 | 26.41 | 0.514 |
| Cocoa solids | (10.77 × 0.46) = 4.95 | 4.13 | (initial Φ₀) |
| Milkpowder | (22.73 × 0.74) = 16.82 | 12.53 | |
| defatted | | | |
| Solids | 63.63 | 43.07 | |
| total | 100.00 | 83.74 | 1.000 |

TABLE 5
Calculation of PGPR dosage in the final state
Initial state Φ₀ = 0.53

| | Mass | Volume m/d | Solid Phase |
|---|---|---|---|
| Compound | m (g) | (mL) | volume |
| Fat (including | 34.15 | (43.07/0.53) × | 0.47 |
| PGPR) | | 0.47 = 38.19 | |
| Sugar | 41.86 | 26.41 | 0.53 |
| Cocoa solids | 4.95 | 4.13 | (target Φ₀) |
| Milk powder | 16.82 | 12.53 | |
| defatted | | | |
| Solids | 61.06 | 43.07 | |
| total | 95.21 | (43.07/0.53) = | 1.000 |
| | | 81.26 | |

Per 100 g total mass in the initial state, the quantity of total fat to remove is 2.22 g (36.37-34.15) but this include PGPR to add that is 0.95 g (1.5%×63.63 g solids)

So 3.17 g fat is first removed after centrifugation then 0.95 g PGPR is added.

After addition of PGPR, the contents are mixed with the RWD 20 Digital IKA stirrer with 4 bladed propeller set at 840 rpm for 5 minutes. The deflocculated chocolate is ready for centrifugation.

### Centrifuge Procedure:

1) Centrifuge Tubes Filling

Put the empty tube in a tube holder where the diameter is slightly higher than the test tube in order to fill the tubes in vertical position, that is without tilting as occurring if holder diameter is too large and tube holder height is too low.

Transfer the PGPR-deflocculated chocolate to the 45 mL mark, close the tube with the screw cap and use the fine marker pen to draw 4 lines on the bottom and on the top. The 4 lines are at the crossing of the 2 diagonals.

The procedure is done on 3 different tubes for an average of 3 replicates.

2) Centrifuge Pre-Warming and Start-Up

The centrifuge is thermostated prior first centrifugation step. The pre-warming takes −20 minutes and is spinning at 4153 rpm to create a stream of hot air. Therefore, the pre-warming is done without tubes.

The centrifuge has 2 modes for selecting speed/RCF. The operating mode is rotational speed in rpm.

Selecting parameters are:

Acceleration speed 1 (low)

Breaking speed 1 (low)

Temperature 40° C.

TABLE 6
Centrifugation steps

| Centrifugation | Rotational speed | Runningtime | Temperature |
|---|---|---|---|
| step | (rpm) | (hour)* | (° C.) |
| 1 | 1613 | 1 | 40.00 |
| 2 | 2280 | 1 | |
| 3 | 2593 | 1 | |
| 4 | 4500 | 3 | |
| 5 | 4500 | 1 | |
| 6 | 4500 | 1 | |
| 7 | 4500 | 1 | |

At the end of centrifugation step 5, record the initial height (H₀) and the height of the dividing line between solids and fat after the centrifugation process (H_{equilibrium}) The initial height is the total height of the mixture that is put into the tube (including both the solid and fat phases). However, the mixture may initially contain air bubbles which will distort the results. Therefore, the measurement of the total height is made after centrifugation so that the bubbles can be removed by the centrifugation and the actual total height can be measured.

Steps 6 and 7 are to check that both heights are constant.

If not, proceed to an extra 1 hour step until constant.

### Results:

The maximum packing fraction is:

ϕₘₐₓ=ϕ₀[H₀/H_{equilibrium}]

Report the value to the nearest 2 decimal places taking the average of 3 measurements (3 separate 50 mL centrifuge tubes).

2. Measuring Rheological Properties (Plastic Viscosity and Yield Stress) Apparatus:
C-VOR Bohlin Rheometer equipped with thermostatically controlled water bath at 40° C. The vane geometry is used for the measurements. The Vane tool diameter is 25 mm and its high is 40 mm, the outer cup diameter is 50 mm and its depth is 60 mm
Turbo-Test Rayneri VMI mixer
600 mL glass beaker (VWR Collection).
Metal spatula.
Analytical balance to the nearest 0.01 g.
Fan-assisted oven set at 50° C. for chocolate melting and conditioning prior sample preparation.
Fan-assisted oven set at 50° C. for sunflower oil warming, set at 60° C. for melting milk chocolate with superfine, set at 80° C. for melting dark chocolate with superfine.

### Materials:

Chocolate samples (provided by CARGILL)

### Chocolate Melting:

For regular chocolate, 50° C. melting overnight is sufficient.

For chocolate with superfine particulates, the dark chocolates are melted overnight at 80° C. and the milk chocolates are melted overnight at 60° C.

### Sample Preparation:

Mix the chocolate sample with a metal spatula when you take it out of the oven.

Pour 150 g into a glass beaker. 150 g is the amount needed to fill the vane geometry.

Then mix it using a turbo-test Rayneri VMI mixer at 840 rpm for 5 minutes. The mixing should be done in a hot water bath in order to have the sample at 40° C. after the 5 minutes.

The rheological measurement must be done immediately after the mixing.

The studied samples are:
Sample 1: Mouscron dark chocolate Noir 58 HC5738 AA00 with

Sugar 40.84 w %

Cocoa mass 43.96 w % (composed of 54 w % fat and 46 w % cocoa particles)

Cocoa butter 15.20 w %

Sample 2: Mouscron milk chocolate Lacte Equilibre HL3435 AA00 with

Sugar 41.86 w %

Cocoa mass 10.77 w % (composed of 54 w % fat and 46 w % cocoa particles)

Cocoa butter 24.64 w %

Whole milk powder 22.73 w % (composed of 26 w % fat and 74 w % defatted milk powder)

### Measurement Procedure:

The cup of the rheometer was filled with the sample and the measurement sequence was started.

The sample is pre-sheared for 300 s at a speed of 177 s⁻¹.

After a rest of 3 s, the sample is subjected to a ramp of decreasing shear rate from 100 s⁻¹ to 1 s⁻¹ for 500 s then to a ramp of increasing shear rate from 1 s⁻¹ to 100 s⁻¹ for 500 s.

Choose the linear acquisition to cover the range of shear speed studied.

The sequence of a decreasing then increasing ramp allows us to verify the reproducibility of the measurements, the stability of the sample, and to ensure that the influence of the thixotropy of the system studied on the rheological behaviour is negligible with this protocol.

In the following, we will only study the decreasing curve for data analysis.

### Results:

The flow curves are fitted with the Bingham equation.

The analysis procedure is as following:
Plot the apparent viscosity as a function of the shear rate.
Plot the shear stress as a function of the shear rate but only for the decreasing curve, meaning for shear rates from 100 s⁻¹ to 1 s⁻¹.
Add a linear trend line to the curve in order to have a linear equation as follows: y=ax+b.

The plastic viscosity and yield stress of the sample are given by a and b respectively.

3. Measuring Particle Size Distribution

The particle size distribution of solid particles of chocolate is measured by laser diffractometry (in a deflocculated state).

PGPR is used to disperse the particles in the solvent (i.e. oil). The PGPR dosage required to disperse the particles was determined after several measurements at different dosages (see section PGPR dosage).

### DEFINITION OF TERMS

The calculation of the granulometric distribution is based on the Mie theory.
d₁₀, d₅₀ and d₉₀ are the characteristics diameters obtained from these calculations.
d₁₀ is the volume-based diameter below which 10% of the particles are undersize.
d₅₀ is the volume-based diameter below which 50% of the particles are undersize.
d₉₀ is the volume-based diameter below which 90% of the particles are undersize.

The optical indexes (refractive index and absorption) are required for the granulometric distributions calculation by Mie theory. They are represented by the real and imaginary parts of the complex refractive index of the material, defined by:

N=n−ik

With n being the real part and depending on the nature of the material. The imaginary part, k, represents the absorption of the light beam by the particle crossed. It also depends on the nature of the material, but also on its purity.

The solid particles are:
for dark chocolate: sugar (sucrose), cocoa particles (from cocoa mass)
for milk chocolate: sugar (sucrose), lactose, cocoa particles (from cocoa mass), whole milk powder, skimmed milk powder, whey powder.

Sunflower oil is used as the solvent.

TABLE 7
Indexes and densities:

| | | | Indexes | |
|---|---|---|---|---|
| | Density (g/mL) | | Absorption | Refractive |
| Compound | ≥2 decimals | 2 decimals | (AI) | (RI) |
| Sunflower | 0.8942¹ | 0.89 | — | 1.46 |
| oil | | | | |
| Sugar | 1.5852 | 1.59 | 0.01 | 1.54 |
| Cocoa | 1.20² | 1.20 | 0.1 | 1.59 |
| solids fat | | | | |
| free | | | | |
| Milk | 1.342 | 1.34 | 0.01 | 1.34² |
| powder fat | | | | |
| free | | | | |
| Whey | 1.313 | 1.31 | 0.01 | 1.34² |
| powder fat | | | | |
| free | | | | |

¹The sample is pre-sheared to bring it to a reference structuration state.
²Temperature to remain at 40° C. during the measurement.

Apparatus:
Laser diffractometer, Mastersizer 3000, equipped with a dispersing unit Hydro LV (Malvern Instruments Ltd., Malvern Panalytical, France).
Turbo-Test Rayneri VMI mixer
25 mL glass bottle with pressure cap (VWR Collection).
Metal spatula.
Analytical balance to the nearest 0.01 g.
Plastic Pasteur pipettes.
Fan-assisted oven set at 50° C. for chocolate melting and conditioning prior sample preparation.
Fan-assisted oven set at 50° C. for sunflower oil warming, set at 60° C. for melting milk chocolate with superfine, set at 80° C. for melting dark chocolate with superfine.

### Materials:

Commercial sunflower oil (AUCHAN, France)
Emulsifier: PGPR (provided by CARGILL).
Chocolate samples (provided by CARGILL)

### Chocolate Melting:

For regular chocolate, 50° C. melting overnight is sufficient.

For chocolate with superfine particulates, the dark chocolates are molten overnight at 80° C. and the milk chocolates are molten overnight at 60° C.

### Sample Preparation:

Add 10 g of melted chocolate in a solution containing 7 g of sunflower oil and 1 g of PGPR.

Mix the suspension during 5 min at 840 rpm with Turbo-Test Rayneri VMI mixer to ensure that all the particles are homogeneously dispersed.

Put the suspension in the oven or a water bath overnight at 50° C.

Put 600 ml of sunflower oil at 50° C. overnight for each measurement.

The studied samples are:
Sample 1: Mouscron dark chocolate Noir 58 HC5738 AA00 with

Sugar 40.84 w %

Cocoa mass 43.96 w % (composed of 54 w % fat and 46 w % cocoa particles)

Cocoa butter 15.20 w %

Sample 2: Mouscron milk chocolate Lacte Equilibre HL3435 AA00 with

Sugar 41.86 w %

Cocoa mass 10.77 w % (composed of 54 w % fat and 46 w % cocoa particles)

Cocoa butter 24.64 w %

Whole milk powder 22.73 w % (composed of 26 w % fat and 74 w % defatted milk powder)

### Measurement Procedure:

Enter the parameters required for the measurement (name of the sample, optical indexes of the particles and solvent, shape of the particles . . . ). Make sure to set the software to repeat each measurement 5 times.

Fill the unit cell with the pre-warmed 600 ml sunflower oil and cover the cell.

Poor the sample prepared in the cell until an obscuration between 12-15%.

Measure the particle size distribution.

For dark chocolate samples, two measurements must be done. One measurement using sugar's optical indexes and another one using cocoa's indexes. A particle size distribution by volume is therefore obtained for each measurement.

For milk chocolate samples, the principle is the same but you have to do three measurements instead of two. The third measurement is done with milk's optical indexes.

### Results:

Sample 1: Mouscron dark chocolate Noir 58 HC5738 AA00
1. Average the particle size distribution by volume obtained from the five successive measurements using cocoa's optical indexes.
2. Average the particle size distribution by volume obtained from the five successive measurements using sugar's optical indexes.
3. Estimate the volume proportions of cocoa and sugar particles in the sample.

### Volume Proportion of Sugar (α):

$$α = \frac{Volume of sugar}{Volume of sugar + Volume of cocoa particles}$$

### Volume Proportion of Cocoa Particles (β):

$$β = \frac{Volume of cocoa particles}{Volume of sugar + Volume of cocoa particles}$$

We Recall that:

$$Volume of sugar = \frac{Mass of sugar}{Density of sugar}$$

$$Volume of cocoa particles = \frac{Mass of cocoa particles}{Density of cocoa particles}$$

$$And mass of cocoa particles = 0.46 \times Mass of cocoa mass$$

For sample 1 we find:

$$α = \frac{40.84 / 1.59}{40.84 / 1.59 + ( 0.46 \times 43.96 ) / 1.2} = 0.6$$

$$β = \frac{( 0.46 \times 43.96 ) / 1.2}{40.84 / 1.59 + ( 0.46 \times 43.96 ) / 1.2} = 0.4$$

4. The particle size distribution by volume for dark chocolate is obtained by averaging the average particle size distribution by volume obtained with the optical indexes of cocoa and sugar according to their respective volume proportion.
   For sample 1 at a fixed size:

### Volume Proportion of Dark Chocolate (γ):

γ=(α×the average particle size distribution by volume obtained with cocoa's optical indexes)+((3×the average particle size distribution by volume obtained with sugar's optical indexes)
Sample 2: Mouscron milk chocolate Lacte Equilibre HL3435 AA00

The analysis procedure is the same as the one described previously. However, in this case, milk particles should be consider too. It is therefore necessary to determine their volume proportion.

### Volume Proportion of Sugar (α):

$$α = \frac{Volume of sugar}{Volume of sugar + Volume of cocoa particles + Volume of milk particles}$$

### Volume Proportion of Cocoa Particles (β):

$$β = \frac{Volume of cocoa particles}{Volume of sugar + Volume of cocoa particles + Volume of milk particles}$$

### Volume Proportion of Milk Particles (Φ):

$$Φ = \frac{Volume of milk particles}{Volume of sugar + Volume of cocoa particles + Volume of milk particles}$$

We Recall that:

$$Volume of milk particles = \frac{Mass of milk particles}{Density of milk particles}$$

$$And mass of milk particles = 0.74 \times Mass of whole milk powder$$

For sample 2 we find:

$$α = \frac{41.86 / 1.59}{41.86 / 1.59 + ( 0.46 \times 10.77 ) / 1.2 + ( 0.74 \times 22.73 ) / 1.34} = 0.6$$

$$β = \frac{( 0.46 \times 10.77 ) / 1.59}{41.86 / 1.59 + ( 0.46 \times 10.77 ) / 1.2 + ( 0.74 \times 22.73 ) / 1.34} = 0.1$$

At a fixed size:

### Volume Proportion of Milk Chocolate (δ):

δ=(α×the average particle size distribution by volume obtained with cocoa's optical indexes)+(β×the average particle size distribution by volume obtained with sugar's optical indexes)+(δ×the average particle size distribution by volume obtained with milk's optical indexes)

### EXEMPLARY EMBODIMENTS

The following are exemplary embodiments of the invention.

Exemplary embodiment 1. A reduced fat chocolate composition comprising:

a continuous fat phase, said fat phase comprising a fat and an emulsifier, and

at least two particulate materials distributed throughout said fat phase, wherein the chocolate composition has a solid phase volume x, and a Bingham plastic viscosity value y in Pa·s at 40° C. or above, where:

x is from 0.4 to 0.7; and

y<264x³−330x²+141x−20.

Exemplary embodiment 2. A method of preparing a reduced fat chocolate composition, optionally according to exemplary embodiment 1, the method comprising:

providing an initial chocolate composition comprising at least two particulate materials dispersed throughout the fat phase and the emulsifier;

determining the maximum packing fraction and viscosity of the initial chocolate composition; and

preparing a reduced fat version of the initial chocolate composition by:

determining optimized particle packing parameters for the at least two particulate materials, wherein the optimized particle packing parameters are optimized such that the reduced fat chocolate composition has a maximum packing fraction that is greater than the maximum packing fraction of the initial chocolate composition and a viscosity that is substantially identical to the viscosity of the initial chocolate composition;

selecting the at least two particulate materials having optimized particle packing parameters; and

combining the selected particulate materials with the fat phase and the emulsifier to provide a reduced fat version of the initial chocolate composition.

Exemplary embodiment 3. A method according to exemplary embodiment 2, wherein the particle packing parameters include particle size distribution, particle shape, and/or the relative amounts of the at least two particulate materials.

Exemplary embodiment 4. A method according to exemplary embodiment 2 or 3, wherein the optimized particle packing parameters are optimized such that the reduced fat chocolate composition has a maximum packing fraction that is at least 1% greater than the maximum packing fraction of the initial chocolate composition.

Exemplary embodiment 5. A method according to any one of exemplary embodiments 2-4, wherein the maximum packing fraction is determined using software that predicts maximum packing fraction based on input values of the particle size distribution and/or shape of the particulate materials, or wherein the maximum packing fraction (.) is determined experimentally by measurement method 1.

Exemplary embodiment 6. A reduced fat chocolate composition obtained or obtainable by the method of any one exemplary embodiments 2-5.

Exemplary embodiment 7. A reduced fat chocolate composition according to exemplary embodiment 1 or 6, comprising:

at least two particulate materials dispersed throughout a continuous fat phase, and an emulsifier,

the at least two particulate materials having different D50 particle sizes to each other.

Exemplary embodiment 8. A reduced fat chocolate composition according to exemplary embodiment 7, wherein the D50 particle sizes of the at least two particulate materials are different to each other by a factor of between 3 and 12.

Exemplary embodiment 9. A reduced fat chocolate composition according to any one of exemplary embodiments 1 or 6-8, having a Bingham viscosity value of between 0.1 and 10 Pa·s and a Bingham yield stress of between 1 and 150 Pa, at 40° C.

Exemplary embodiment 10. A reduced fat chocolate composition according to any one of exemplary embodiments 1 or 6-18, wherein the total fat content of the reduced fat chocolate composition is up to 20% less than the total fat content of the initial chocolate composition.

Exemplary embodiment 11. A reduced fat chocolate composition according to exemplary embodiment 10, wherein the total fat content is 31-33% for a moulding application, 25-27% for an extrusion application, 37-40% for an enrobing application, or 44-46% for an ice cream dipping application.

Exemplary embodiment 12. A method or reduced fat chocolate composition according to any one of the preceding exemplary embodiments wherein the at least two particulate materials are selected from the group consisting of sugars, cocoa solids, milk solids, bulking agents, calcium carbonate, nutritional particles, and flavorings and/or mixtures of two or more thereof.

Exemplary embodiment 13. A method or reduced fat chocolate composition according to any one of the preceding exemplary embodiments, wherein the fat in the fat phase comprises cocoa butter, cocoa butter equivalents, cocoa butter alternatives, anhydrous milk fat, fractions thereof and/or mixtures of two or more thereof.

Exemplary embodiment 14. A method or reduced fat chocolate composition according to any one of the preceding exemplary embodiments, wherein the emulsifier is selected from the group consisting of: lecithin, soy lecithin, polyglycerol polyricinoleate (PGPR), ammonium phosphatide (AMP), sorbitan tristearate, sucrose polyerucate, sucrose polystearate, phosphated mono-di-glycerides/diacetyl tartaric acid of mono glycerides.

Exemplary embodiment 15. A food product comprising a reduced fat chocolate composition according to any one of exemplary embodiments 1 or 6-14.

### EXAMPLES

### Example 1—Preparation of Sweet Fat

1. A mixture of 11.7 kg (78%) crystal sugar (weight) plus 3.3 kg (22%) liquid cocoa butter is thoroughly mixed using a Stephan mixer
2. This mixture is passed through a triple roll refiner.
3. The flakes obtained are collected.
4. These flakes are passed a second time through the same triple roll refiner;
5. 0.15 kg (1%) of cocoa butter is added to the double ground flakes.
6. This mixture is transferred to a Colette conche (vertical axis).
7. It is conched for 5 hrs at 60° C.
   The D50 particle size of the sugar in the sweet fat is 10.86 μm.

### Example 2—Determination of Chocolate Formulations with Higher Maximum Packing Fraction

Commercial dark chocolates for enrobing, moulding, ice cream and extrusion application were analysed for particle size distribution (PSD) and flow behaviour. It was found that the PSD is similar for all the applications and that the flow behaviour depends upon the amount of cocoa butter.

In order to carry out comparative testing more easily, the commercial chocolate compositions were recreated with sweet fat (prepared according to example 1) and coarse cocoa particles having a D50 particle size of 9.20 μm to give chocolates with the same composition and the same PSD as the commercial chocolates (formulations 1 in tables 8-12).

Formulations were then prepared having the same composition by weight as the recreated commercial chocolates, but where 50% of the coarse cocoa particles were replaced with fine cocoa particles having a D50 particle size of 2.60 μm (formulations 2 in tables 8-12). Formulations were also prepared having the same composition by weight as the recreated commercial chocolates, but where 100% of the coarse cocoa particles were replaced with fine cocoa particles (formulations 3 in tables 8-12).

TABLE 8
Moulding application

| | Formulation 1 | | |
|---|---|---|---|
| | (commercial | Formulation | Formulation |
| Mass % | chocolate) | 2 | 3 |
| Sugar (sweet fat) | 47.70 | 49.17 | 49.51 |
| Cocoa mass (46% cocoa | 42.70 | 21.96 | 0.00 |
| particles + 54% fat) | | | |
| Fine cocoa mass (46% cocoa | 0.00 | 21.96 | 44.23 |
| fine part. + 54% fat) | | | |
| Cocoa butter (to add) | 9.29 | 6.49 | 5.84 |
| Lecithin | 0.40 | 0.41 | 0.42 |

Formulation 1 φ is 0.56.
Formulation 3 φ is 0.58.

TABLE 9
Extrusion application

| | Formulation 1 | | |
|---|---|---|---|
| | (commercial | Formulation | Formulation |
| Mass % | chocolate) | 2 | 3 |
| Sugar (sweet fat) | 58.50 | 59.82 | 60.42 |
| Cocoa mass (46% cocoa | 33.00 | 16.87 | 0.00 |
| particles + 54% fat) | | | |
| Fine cocoa mass (46% | 0.00 | 16.87 | 34.08 |
| cocoa fine part. + 54% fat) | | | |
| Cocoa butter (to add) | 8.00 | 5.92 | 4.99 |
| Lecithin | 0.50 | 0.51 | 0.52 |

Formulation 1 φ is 0.63.
Formulation 3 φ is 0.65.

TABLE 10
Enrobing application

| | Formulation 1 | | |
|---|---|---|---|
| | (commercial | Formulation | Formulation |
| Mass % | chocolate) | 2 | 3 |
| Sugar (sweet fat) | 40.60 | 41.68 | 42.11 |
| Cocoa mass (46% cocoa | 43.70 | 22.43 | 0.00 |
| particles + 54% fat) | | | |
| Fine cocoa mass (46% cocoa | 0.00 | 22.43 | 45.32 |
| fine part. + 54% fat) | | | |
| Cocoa butter (to add) | 15.10 | 12.84 | 11.94 |
| Lecithin | 0.60 | 0.62 | 0.62 |

Formulation 1 φ is 0.49.
Formulation 3 φ is 0.51.

TABLE 11
Ice cream application

| | Formulation 1 | | |
|---|---|---|---|
| | (commercial | Formulation | Formulation |
| Mass % | chocolate) | 2 | 3 |
| Sugar (sweet fat) | 39.50 | 40.50 | 40.81 |
| Cocoa mass (46% cocoa | 32.50 | 16.66 | 0.00 |
| particles + 54% fat) | | | |
| Fine cocoa mass (46% cocoa | 0.00 | 16.66 | 33.57 |
| fine part. + 54% fat) | | | |
| Cocoa butter (to add) | 27.50 | 25.66 | 25.10 |
| Lecithin | 0.50 | 0.51 | 0.52 |

Formulation 1 φ is 0.43.
Formulation 3 φ is 0.44.

Viscosity and yield stress were measured according to the methods described above and plotted against fat content. The results are shown in in table 12.

TABLE 12
Fat content vs. Bingham viscosity and yield stress.

| | | | | Total | Maximum |
|---|---|---|---|---|---|
| | | | Yield | fat | packing |
| | | Viscosity | stress | content | fraction |
| | | (Pa · s) | (Pa) | (%) | (Φmax) |
| Formulation | Extrusion | 4 | 95 | 25.82 | 0.715 |
| 1 | Moulding | 2 | 36 | 32.3 | 0.693 |
| (commercial | Enrobing | 1 | 11 | 38.7 | 0.681 |
| chocolate) | Ice cream | 0.6 | 3.3 | 45.05 | 0.681 |
| Formulation | Extrusion | 4 | 110 | 24.17 | 0.733 |
| 2 | Moulding | 2.1 | 47 | 30.21 | 0.715 |
| | Enrobing | 1 | 14 | 36.61 | 0.705 |
| | Ice cream | 0.6 | 3.4 | 43.11 | 0.702 |
| Formulation | Extrusion | — | — | — | 0.742 |
| 3 | Moulding | — | — | — | 0.722 |
| | Enrobing | 1.1 | 17 | 34.66 | 0.713 |
| | Ice cream | 0.68 | 6.7 | 41.73 | 0.709 |

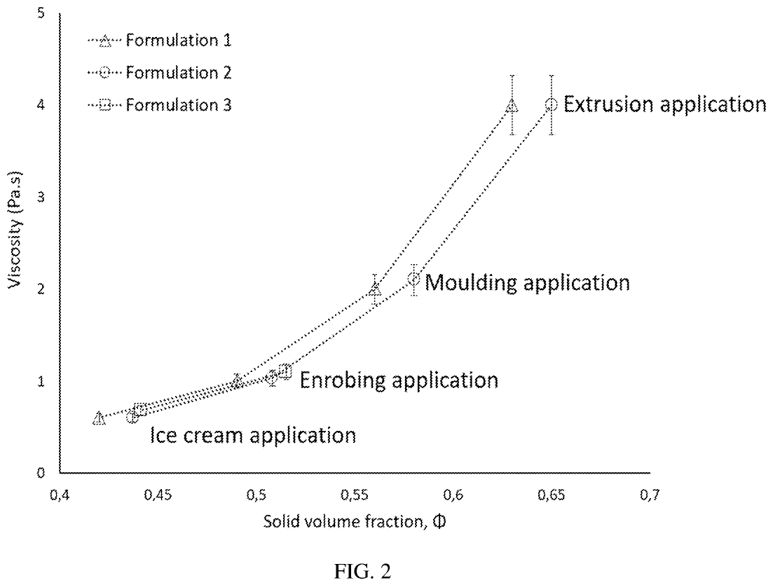

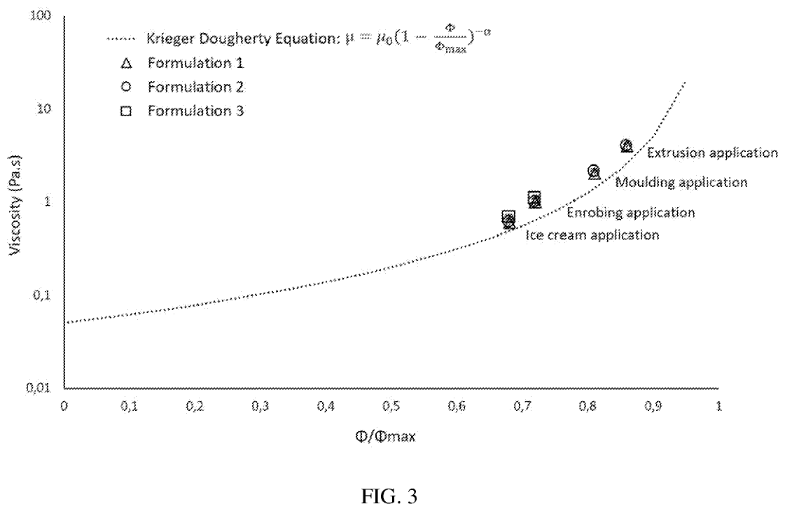

The maximum packing fraction of the formulations was calculated according to the above measurement method 1. FIGS. 2 and 3 show the correlation between morphology and rhelology of the formulations.

The results show that the maximum packing fraction of formulations 2 and 3 is greater than that of the equivalent commercial chocolate composition, whilst the viscosity and yield stress of formulations 2 and 3 is very similar to that of the equivalent commercial chocolate formulation, and the fat content is reduced. Therefore, the present invention allows for the manufacture of a lower fat, lower calorie chocolate that behaves rheologically like a chocolate with higher fat. This benefit is consistent across the range of chocolate applications.

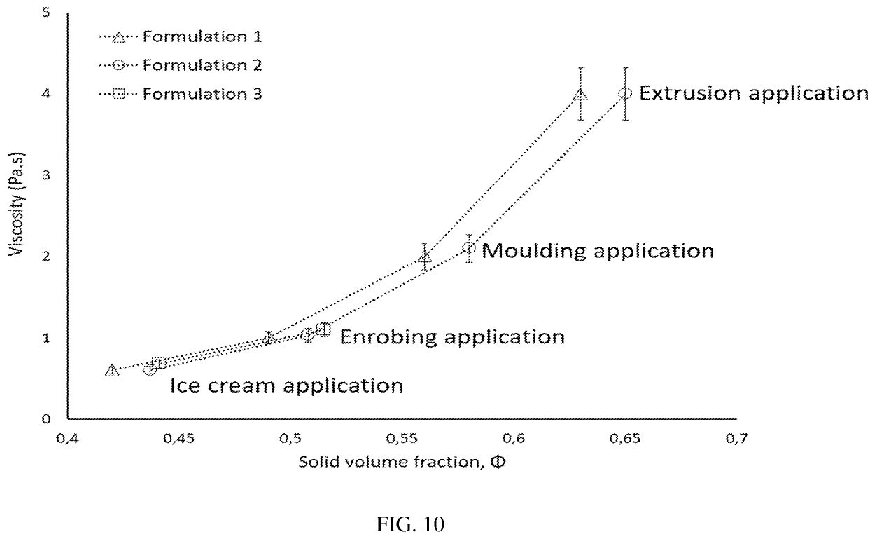

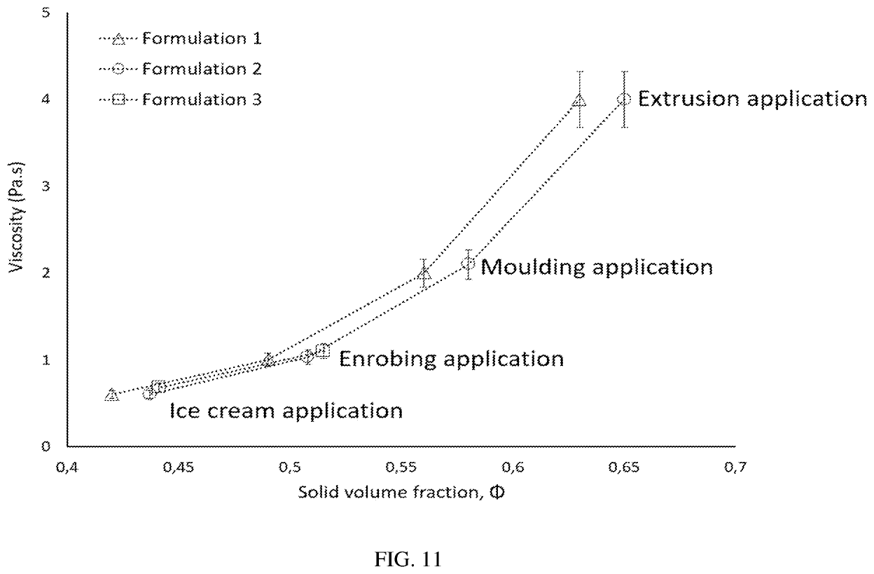

FIG. 10 shows the % reduction in fat for formulation 2 compared to formulation 1. FIG. 11 further shows the % reduction in fat for formulation 3.

### Example 3—Comparison with Reduced-Fat Chocolate Described in EP1061813

EP1061813 discloses a “reduced-fat chocolate” in example 5. The objective of this study was to analyze said chocolate to determine whether or not it corresponds to the reduced fat chocolate compositions described herein.

The particle size distributions of the particulate materials described in example 5 of EP1061813 were determined by reference to FIG. 2 a of said document.

The density of the skimmed milk powder was not measured. However, in the literature the quoted density is 1.13 kg/m3 (see Walstra P, J T M Wouters and T J Geurts 2006 Dairy Technology 2^{nd} edition CRC/Taylor & Francis, which is herein incorporated by reference.

The ratios (by weight) of the particulate materials disclosed in example 5 of EP1061813 are:

Sugar 68.5%

Skimmed milk powder 25.4%

Cocoa Powder 6.1%

The above values were input into a Microsoft Excel™ spreadsheet that had been programmed to follow the de Larrard approach (CPM) described above and in Gonçalves, E. V.; Lannes, S. C. d. S Food Sci. Technol. 2010, 30, 845-851. This output a maximum packing fraction value of 0.54. This value is low relative to the maximum packing fraction values described herein (greater than or equal to 0.60). Without being bound by theory, it is believed that this is because the particle size of the cocoa powder and the skimmed milk powder are very similar in EP1061813.

The ratios of the particulate materials described in EP1061813 were then varied to observe the effect on the maximum packing fraction value. The results are shown in table 13 (CP_{Mars}) Varying the ratio had little effect on the maximum packing fraction value.

For comparative purposes, the same ratios were then investigated but the cocoa powder was substituted in the model for a theoretical cocoa powder having a finer particle size of 1.8 μm. These results are also shown in table 13 (CP_{1.8 μm}). Substituting the cocoa powder consistently resulted in higher maximum packing fraction values.

TABLE 13
Effect of varying dry ingredient ratios
on maximum packing fraction value.

| | CP_{Mars} | CP_{1.8μm} |
|---|---|---|
| Sugar 68, SMP* 25, CP** 7 | 0.528 | 0.594 |
| Sugar 76 SMP 19, CP 5 | 0.542 | 0.582 |
| Sugar 67 SMP 28 CP 5 | 0.539 | 0.597 |
| Sugar 65 SMP 25 CP10 | 0.545 | 0.603 |
| Sugar 50 SMP 25 CP 25 | 0.56 | 0.621 |
| Sugar 34 SMP 33 CP 33 | 0.532 | 0.622 |

*SMP = skimmed milk powder
**CP = cocoa powder

### Example 4—Effect of Particle Shape on the Maximum Packing Fraction Computed from the Compressible Packing Model

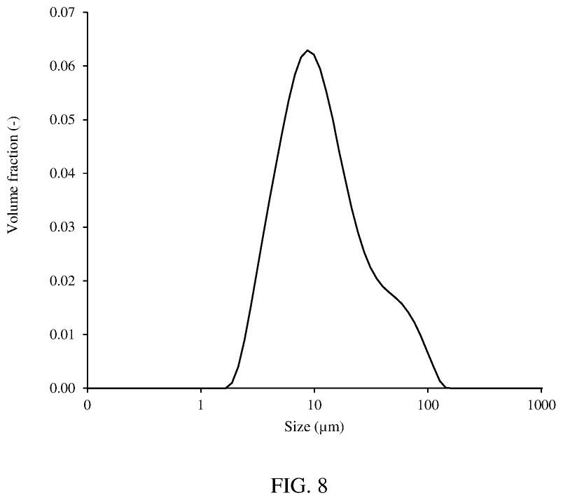

A typical cocoa powder having the particle size distribution shown in FIG. 8 (measured by granulometry) and a maximum packing fraction of 0.49 (measured by centrifugation) was studied.

From the particle size distribution and the maximum packing fraction of the powder, the Compressible Packing Model (CPM) allows for the computation of a unique shape coefficient β of the powder (equal here to 0.42 as shown in FIG. 2). The shape coefficient β corresponds to the maximum packing fraction of a monodisperse powder with the same particle shape. When dealing with polydisperse powders, the model assumes that, for the same powder, the shape of a particle is independent on the size classes.

In order to study the effect of the shape coefficient on the maximum packing fraction of cocoa, we vary here the shape coefficient and compute from the CPM the corresponding maximum packing fraction while keeping the particle size distribution from FIG. 8.

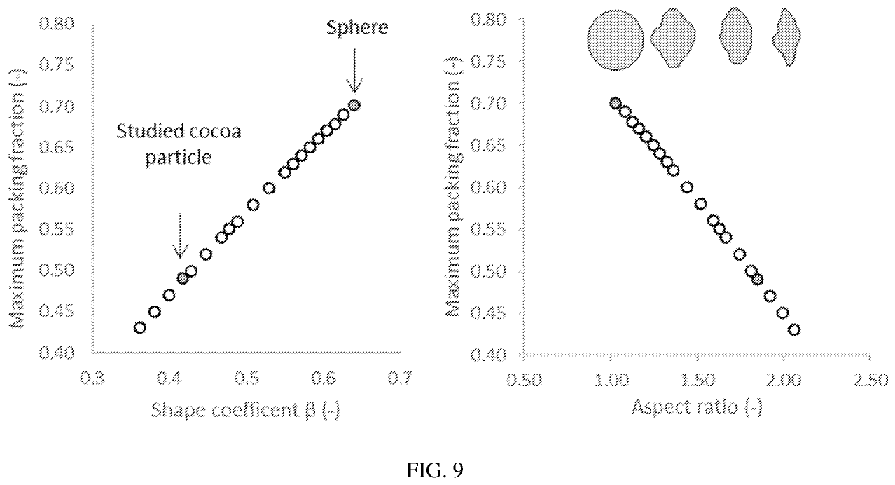

FIG. 9a shows the maximum packing fraction as a function of the shape coefficient for a cocoa powder having a constant particle size distribution computed from CPM. It was noted that an increase of the shape coefficient leads to an increase of the maximum packing fraction of the powder. A shape coefficient equal to 0.64 corresponds to a sphere.

It is shown in literature that particle aspect ratio is one of the main parameters influencing the particle maximum packing fraction. The aspect ratio of these powders were computed from the semi empirical equation developed by Ahmadah et al. (Oumayma Ahmadah, Contrôle de la rhéologie des liants à faibles impacts environnementaux, Universitë Gustave Eiffel, Thèse 2021) and the maximum packing fraction was plotted as a function of the aspect ratio (Cf. FIG. 9b). It was noted that decreasing the aspect ratio of particles while maintaining the particle size distribution constant leads to an increase of the maximum packing fraction.

As described herein, increasing the maximum packing fraction of a powder allows for a decrease of the cocoa butter content in a chocolate composition while maintaining the viscosity constant. As an example, for a reference cocoa liquor composed of the cocoa particle studied here and containing 54% of cocoa butter by total mass (i.e. a solid phase volume equal to 0.39). An increase of the shape coefficient from 0.42 to 0.59 (i.e. a decrease of the aspect ratio from 1.8 to 1.2) leads to a decrease of cocoa butter content from 54% to 41%.

These results show that the method of the invention, which utilizes CPM, takes the shape of the particles into account and that the influence of particle shape on packing properties and therefore on chocolate composition ingredient selection is of a critical importance.

### Example 5—Validation Study

Samples of typical dark chocolates for different applications manufactured by Cargill Inc. as well as commercially available chocolate samples were analyzed in order to test the validity of the CPM described herein.

TABLE 14
Composition of the typical Cargill Inc. chocolates.

| | | Cocoa | | | | |
|---|---|---|---|---|---|---|
| | Sugar | particles | Fat | Lecithin | | |
| | (wt %) | (wt %) | (wt %) | (wt %) | φ | φmax |
| Extrusion | 58.5 | 15.18 | 25.82 | 0.5 | 0.63 | 0.7 |
| Enrobing | 47.7 | 19.6 | 32.2 | 0.4 | 0.56 | 0.74 |
| Molding | 40.6 | 20.1 | 38.7 | 0.6 | 0.49 | 0.68 |
| Ice cream | 39.5 | 14.95 | 45.05 | 0.5 | 0.42 | 0.66 |

TABLE 15
Rheological properties of the typical Cargill Inc. chocolates
(as measured according to the methods described herein.)

| | | Yield |
|---|---|---|
| | Viscosity | stress |
| | (Pa · s) | (Pa) |
| Extrusion | 4.8 | 107 |
| Enrobing | 2.3 | 30.8 |
| Molding | 1.1 | 17 |
| Ice | 0.6 | 2.8 |
| cream | | |

Commercial dark chocolates were purchased in the supermarket. Jacques, 365 Essential (Delhaize private label) and Delicata.

TABLE 16
Compositions of the commercial chocolates
(lecithin content is assumed).

| | | Cocoa | | | | |
|---|---|---|---|---|---|---|
| | Sugar | particles | Fat | Lecithin | | |
| | (wt %) | (wt %) | (wt %) | (wt %) | φ | φmax |
| Jacques | 48.31 | 19.78 | 31.4 | 0.51 | 0.57 | 0.64 |
| 365 Essential | 49.75 | 17.74 | 32 | 0.51 | 0.56 | 0.64 |
| Delicata | 41.62 | 21.48 | 36.39 | 0.51 | 0.52 | 0.67 |

TABLE 17
Rheological properties of the commercial chocolates
(as measured according to the methods described herein.)

| | | Yield |
|---|---|---|
| | Viscosity | stress |
| | (Pa · s) | (Pa) |
| Jacques | 2.68 | 50.68 |
| 365 | 2.57 | 35.91 |
| Essential | | |
| Delicata | 1.7 | 24.07 |

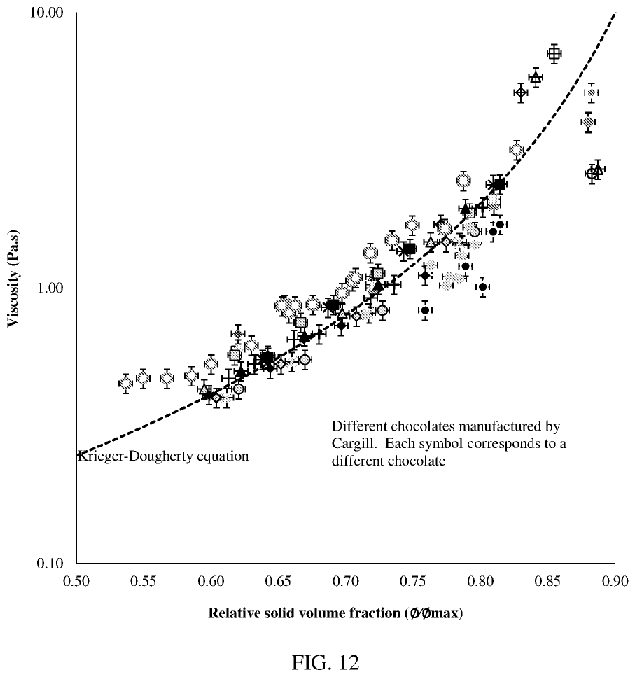

As can be seen from FIG. 12, both the Cargill Inc. samples and the commercial samples fit the master Krieger-Dougherty equation curve of the performance that was expected. These results show that the CPM described herein can be used to predict the performance of chocolates.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A reduced fat chocolate composition comprising:
a continuous fat phase, said fat phase comprising a fat and an emulsifier; and
at least two particulate materials distributed throughout said fat phase;
wherein the at least two particulate materials have different D50 particle sizes to each other, said difference being a factor of 6-8.

2. The reduced fat chocolate composition according to claim 1, having a solid phase volume x, and a Bingham plastic viscosity value y in Pa·s at 40° C. or above, where:
x is from 0.4 to 0.7; and
y<264x³−330x²+141x−20.

3. The reduced fat chocolate composition according to claim 1, having a Bingham plastic viscosity value of between 0.1 and 10 Pa·s and a Bingham yield stress of between 1 and 150 Pa, at 40° C.

4. The reduced fat chocolate composition according to claim 1, wherein the total fat content is 31-33% for a moulding application, 25-27% for an extrusion application, 37-40% for an enrobing application, or 44-46% for an ice cream dipping application.

5. A food product comprising the reduced fat chocolate composition according to claim 1.

6. A method of preparing a reduced fat chocolate composition, the method comprising:
(a) providing an initial chocolate composition comprising
a continuous fat phase, said fat phase comprising a fat and an emulsifier; and
at least two particulate materials distributed throughout said fat phase;
(b) optionally measuring the maximum packing fraction and viscosity of the initial chocolate composition; and
(c) preparing a reduced fat version of the initial chocolate composition by:
i. determining optimized particle packing parameters for the at least two particulate materials of the initial chocolate composition, wherein the optimized particle packing parameters are optimized such that the reduced fat chocolate composition has a maximum packing fraction value that is greater than the maximum packing fraction value of the initial chocolate composition and a viscosity that is substantially identical to the viscosity of the initial chocolate composition;
ii. selecting for the reduced fat chocolate composition at least two particulate materials that are identical to the at least two particulate materials of the initial chocolate composition but for having the optimized particle packing parameters; and
iii. combining the selected particulate materials with a fat phase and emulsifier that are identical to the fat phase and emulsifier of the initial chocolate composition to provide a reduced fat version of the initial chocolate composition.

7. The method according to claim 6, wherein the particle packing parameters include particle size distribution, particle shape, and/or the relative amounts of the at least two particulate materials.

8. The method according to claim 6, wherein the optimized particle packing parameters are optimized such that the reduced fat chocolate composition has a maximum packing fraction that is at least 1% greater than the maximum packing fraction of the initial chocolate composition.

9. The method according to claim 6, wherein the optimized particle packing parameters are determined using mathematical modelling.

10. The method according to claim 9, wherein the mathematical model used is the compressible packing model described herein.

11. The reduced fat chocolate composition obtained or obtainable by the method of claim 6.

12. The reduced fat chocolate composition according to claim 1, wherein the at least two particulate materials are selected from the group consisting of sugars, cocoa solids, milk solids, bulking agents, calcium carbonate, nutritional particles, and flavorings and/or mixtures of two or more thereof.

13. The reduced fat chocolate composition according to claim 1, wherein the fat in the fat phase comprises cocoa butter, cocoa butter equivalents, cocoa butter alternatives, anhydrous milk fat, fractions thereof and/or mixtures of two or more thereof.

14. The reduced fat chocolate composition according to claim 1, wherein the emulsifier is selected from the group consisting of lecithin, soy lecithin, polyglycerol polyricinoleate (PGPR), ammonium phosphatide (AMP), sorbitan tristearate, sucrose polyerucate, sucrose polystearate, and phosphated mono-di-glycerides/diacetyl tartaric acid of mono glycerides.

15. The method according to claim 6, wherein the at least two particulate materials are selected from the group consisting of sugars, cocoa solids, milk solids, bulking agents, calcium carbonate, nutritional particles, and flavorings and/or mixtures of two or more thereof.

16. The method according to claim 6, wherein the fat in the fat phase comprises cocoa butter, cocoa butter equivalents, cocoa butter alternatives, anhydrous milk fat, fractions thereof and/or mixtures of two or more thereof.

17. The method according to claim 6, wherein the emulsifier is selected from the group consisting of lecithin, soy lecithin, polyglycerol polyricinoleate (PGPR), ammonium phosphatide (AMP), sorbitan tristearate, sucrose polyerucate, sucrose polystearate, and phosphated mono-di-glycerides/diacetyl tartaric acid of mono glycerides.
